(19) United States
(12) Patent Application Publication
(10) Pub. No.: US 2022/0397055 A1
(43) Pub. Date: Dec. 15, 2022

(54) INTERNAL COMBUSTION ENGINE WITH ROTATING PISTONS AND CYLINDERS AND RELATED DEVICES AND METHODS OF USING THE SAME

(71) Applicant: Dorce Daniel, Springville, CA (US)

(72) Inventor: Dorce Daniel, Springville, CA (US)

(21) Appl. No.: 17/555,366

(22) Filed: Dec. 17, 2021

Related U.S. Application Data
(63) Continuation-in-part of application No. 17/468,667, filed on Sep. 7, 2021, now abandoned.
Application No. 17/468,667 is a continuation of application No. 17/241,037, filed on Apr. 26, 2021, now abandoned.
Application No. 17/241,037 is a continuation of application No. 17/175,591, filed on Feb. 12, 2021.
Application No. 17/175,591 is a continuation of application No. 16/799,850, filed on Feb. 25, 2020, now Pat. No. 10,920,663.
Application No. 16/799,850 is a continuation of application No. 16/733,208, filed on Jan. 2, 2020, now abandoned.
(60) Provisional application No. 63/222,416, filed on Jul. 16, 2021.
(60) Provisional application No. 62/938,958, filed on Nov. 22, 2019.

(51) Int. Cl. F02B 59/00; F02B 57/02; F02B 75/32; F01N 13/10; F02B 57/04

(52) U.S. Cl. CPC F02B 59/00; F02B 57/02; F02B 75/32; F01N 13/10; F02B 57/04

(57) ABSTRACT

The present invention provides a novel internal combustion engine design and methods for using the same. The internal combustion engine of the present invention may include two rotors on which the pistons and cylinders and pistons are mounted, respectively. A plurality of cylinders mounted on a cylinder rotor, and a plurality of pistons mounted on a piston rod rotor, where the arrangements of the pistons and cylinders are complementary and each piston is paired with one of the cylinders. The cylinder rotor and the piston rod rotor may be position at oblique angle relative to one another, such that their central axes are located on a same plane, but the axes are not coaxially aligned and intersect on that plane.

### FIELD OF THE INVENTION

The present invention relates to a new internal combustion engine design and related apparatuses and methods of using the same. More particularly, the present invention relates to an internal combustion engine having rotating pistons and cylinders.

### DISCUSSION OF THE BACKGROUND

Conventional internal combustion engines have pistons that move in and out (reciprocate) of cylinders in a stationary cylinder block. Combustion in the cylinders is timed to cause the pistons to be ejected from the cylinder and to turn a crank shaft, converting the chemical energy of the fuel into rotary motion during a power stroke. The power stroke provides driving force for the engine, turning a crank shaft, which in turn performs work through a transmission system that transfers that power to turn the wheels. Conventional combustion engines have widespread adoption, but these engines are inefficient. Around 60 percent or more of the fuel's energy is lost in the internal combustion engine, losing energy to engine friction and shaking, pumping air into and out of the engine, and wasted heat. Modern gasoline engines have a maximum thermal efficiency of about 20% to 35%, when the engine is operating at its point of maximum thermal efficiency. Thus, about 65% to 80% of total power is emitted as heat without being turned into useful work.

The existing designs for internal combustion engines are insufficient, and are in need of improvement. It is therefore desirable to provide novel engines and methods.

### SUMMARY OF THE INVENTION

Embodiments of the present invention provide a novel internal combustion engine design and methods for using the same. The internal combustion engine of the present invention may include two rotors on which the pistons and cylinders and pistons are mounted, respectively. A plurality of cylinders mounted on a cylinder rotor, and a plurality of pistons mounted on a piston rod rotor, where the arrangements of the pistons and cylinders are complementary and each piston is paired with one of the cylinders. The cylinder rotor and the piston rod rotor may be position at oblique angle relative to one another, such that their central axes are located on a same plane, but the axes are not coaxially aligned and intersect on that plane. The relative angle between the central axes of the piston rotor and the cylinder rotor may be in a range of about 120° to about 160°. The piston rotor and the cylinder rotor are operable to rotate at the same rotation speed in coordinated fashion such that the pistons and cylinders remain paired and aligned along one plane (e.g., a vertical plane). This angle results in the piston of each pair moving in and out of the cylinder as the piston rotor and the cylinder rotor rotate in synchrony. Thus, as the cylinder rotor and piston rotor rotate, the pistons orbit about the rotation axis of the piston rotor at angle such that the distance from the piston to the cylinder rotor is greatest at the bottom position of the rotational path of the piston rotor and the distance from the cylinder rotor is least at the top of the rotational path of the piston rotor. As a result, the free volume of the corresponding cylinder is greatest at the bottom of the rotational path and smallest at the top of the rotational path. Due to the relative angle of the piston and cylinder rotors, each piston and cylinder combination undergoes one stroke for every 180 rotation of the piston and cylinder rotors. Thus, compression and expansion of gases in the cylinders can take place with a continuous motion of both the cylinder rotors and the piston rotor to eliminate the loss of efficiency of a conventional engine.

The engine of the present invention may operate as a four-stroke internal combustion engine. The combustion cycle of the engine may be as follows:
Intake stroke: an empty piston and cylinder combination traveling 180° from the top position of the rotational path (e.g., top dead center) to the bottom position (e.g., bottom dead center) may undergo the intake stroke as the volume in the cylinder goes from its smallest to largest condition without exhaust gas in the cylinder, thereby creating a vacuum in the cylinder to draw in a fuel (e.g., an air-fuel mixture, a natural gas fuel, etc.).
Compression stroke: the piston and cylinder combination filled with fuel traveling 180° from the bottom position of the rotational path to the top position may undergo the compression stroke as the fuel in the cylinder is compressed as the volume in the cylinder goes from its largest to smallest condition thereby compressing the fuel to a high pressure condition.
Power stroke: a spark plug or other ignition source delivers a spark into the cylinder filled with highly compressed fuel as the piston and cylinder combination are present at the top position of the rotational path. The spark ignites the compressed fuel resulting in an explosive force that propels the piston head toward the distal end of the cylinder. The power stroke is the force driving the rotation of the engine and occupies a 180° rotation of the cylinder and piston rotors, placing them at the bottom position of the rotational path.
Exhaust stroke: the piston and cylinder combination filled with exhaust gas traveling 180° from the bottom position of the rotational path to the top position may undergo the exhaust stroke as the exhaust gas in the cylinder is pushed of the cylinder as the exhaust valve is opened and the volume in the cylinder goes from its largest to smallest condition thereby pushing the exhaust gas out of the cylinder by increasing the pressure on the exhaust gas.

The rotation of the cylinder rotor may drive a power shaft that provides power to a transmission for use in powering a motor vehicle, a pump, a generator, or other system that can be driven by a shaft. The rotational operation of the engine provides a more efficient utilization of the power stroke of the engine, creating rotational momentum in the absence the series of joints, as found between the piston and camshaft of a conventional four-stroke engine, to transmit the energy from the power stroke to a power shaft. The presently disclosed rotary engine eliminates substantial amounts of wasted vibrational and frictional energy loss that is typical of the reciprocating action of conventional internal combustion engines. In some embodiments the rotation of the piston rotor may drive a power shaft that provides power to a transmission for use in powering a motor vehicle, a pump a generator, or other system that can be driven by a shaft.

The cylinder and piston rotors may be plate structures that are positioned at an oblique angle relative to one another (e.g., in a range of about 120° to about 160°) with their respective pistons and cylinders extending orthogonally or substantially orthogonally from the rotors and meeting at a central plane (e.g., a vertical plane) that may be a pre-determined distance between the cylinder and piston rotors. In an exemplary embodiment, the central plane may be equidistant from the piston rotor and the cylinder rotor. In some embodiments the angle of the cylinder and piston rotors may be the same relative to the central plane. In other embodiments, the respective angles of the cylinder and piston rotors may be different, but may not vary from each other by more than about 5°. The angled arrangement of the cylinder and piston rotors creates an oscillating distance between corresponding piston heads and cylinders as the cylinder and piston rotors synchronously rotate. At top dead center (e.g., at the top rotational path), the cylinder rotor and the piston rotor are in their closest proximity and the piston head is fully inserted into the corresponding cylinder. As the paired cylinder and piston rotate away from top dead center, they progressively move apart until they reach the bottom dead center position (e.g., at the bottom of the rotational path) 180° from top dead center. Then as the paired cylinder and piston rotate back toward the top of the rotational path, the piston and cylinder progressively move together.

In some embodiments, where the piston rotor may drive a power shaft, the shaft may be axially secured to the center of the piston rotor equidistantly to each of the rod joints and may extend through the rotor. The shaft may have to proximal end having CV joint that may secure to the paired cylinder plate and the distal end may provide a splined shaft for attaching to a power transmission. The CV joint attachment may function to provide support to the shaft such that the shaft does not behave like a cantilever, and to prevent failure axial stress at the mounting location. In some examples, the CV joint may be fixed to the central axis of the cylinder rotor at an equidistance between the cylinders.

The cylinders may be fixedly connected to the cylinder rotor in an orthogonal or substantially orthogonal orientation. The cylinders may be positioned in various arrangements, which correspond to the arrangement of the piston rods on the piston rotor. For example, and without limitation, the cylinders may include three cylinders in a triangular pattern, four cylinders in a square pattern, five cylinders equidistantly arranged around the perimeter of the cylinder rotor, six cylinders arranged equidistantly around the perimeter of the cylinder rotor, and other arrangements. The piston rods may be arranged in a corresponding pattern on the piston rotor. The piston rotor may have piston rods connected thereto in various arrangements, but one that corresponds to the arrangement of cylinders on the cylinder rotor. For example, and without limitation, the piston rods may include three rods in a triangular pattern, four rods in a square pattern, five rods equidistantly arranged around the perimeter of the piston rotor, six rods arranged equidistantly around the perimeter of the piston rotor, and other arrangements. With a greater number of piston and piston chamber combinations the more power can be provided by the engine and also more constant power such that the engine does not rely on momentum in between power strokes of the pistons.

The piston heads may be connected to the piston rod by movable joints. To accommodate the angled arrangement of the piston rotor and the cylinder rotor, the piston heads may be connected to the rods by a movable joint, such as a ball joint to allow 360° rotation with two degrees of freedom relative to the ball joint. The angling of the piston rod relative to the cylinder axis may be limited to about 30° or less within a limited angle range relative to the central axis of the corresponding cylinder (e.g., within a cone having an apex angle of 30° or less) allowing limited movement to accommodate the geometry of the piston cylinder. Other similar mechanical connections between the piston head and piston rod are contemplated within the scope of the present invention as well. The moveable joint may allow for the piston heads reciprocate in and out of the cylinder with sufficient clearances between the piston rods and the walls of the cylinders without interference or seizing.

The piston rods may be connected to the piston rotor by either fixed connection or movable joints. The angled arrangement of the piston rotor and the cylinder rotor and the joints between the piston rods and piston heads may allow for the pistons to be fixed to the piston rotor in an orthogonal manner, with sufficient clearances between the piston rods and the walls of the cylinders without interference or seizing. In other examples, and without limitation, the piston rods may be connected by a movable joint. In one example, the piston rod may be connected to the rod rotor by a pivoting joint with one degree of freedom (e.g., a hinge joint), which may allow for some limited shifting of the piston rod (e.g., inward and outward relative to the center of the piston rotor) to accommodate the geometry of the corresponding piston chamber. This allows the piston rotor to rotate in unison with the cylinder rotor. In other embodiments, other joints such as a ball joint or a universal joint may be used in combination with extending the piston shaft and the cylinder into the center between both rotors and adding a universal joint at the angle where both shafts meet. This arrangement will also allow both rotors to turn in unison.

In another example, the piston rods may each be connected to the piston rotor by a ball joint to allow 360° rotation two degrees of freedom relative to the ball joint. The angling of the piston rod relative to the piston rotor may be limited to about 10° or less within a limited angle range (e.g., within a cone having an apex angle of 10° or less) allowing limited movement to aid in accommodating the geometry of the piston chamber. Other similar mechanical connections between the piston rod and the piston rotor are contemplated within the scope of the present invention as well.

The cylinder rotor may be in mechanical connection with a power shaft that translates the rotation of the cylinder rotor to a transmission system to utilize the power generated by the engine. The power shaft may be fixedly connected to the cylinder rotor such that they rotate together at the same rotational velocity. The intake and exhaust systems may also be positioned on the cylinder rotor such that they rotate with the cylinder rotor as well. The cylinder rotor may include both intake ports for intake of air-fuel mixture during the intake stroke and exhaust ports to expel the combustion exhaust gas during the exhaust stroke. Each cylinder may have at least one intake port and at least one exhaust port in the cylinder rotor at the top of the cylinder.

In some embodiments, the piston rotor may be in mechanical connection with a power shaft that translates the rotation of the piston rotor to a transmission system. The power shaft may have two ends, a proximal and a distal end, both having splined end points. The power shaft may be fixedly connected to the piston rotor at some distance between the proximal and distal end points. The cylinder plate may have a CV joint and outer race operable to receive and stabilize the power shaft's splined proximal end. The CV joint may enable the shaft to rotate with limited friction and may act as a slipping support (e.g., bearing), and the outer race may seal the CV joint. The CV joint may have a splined cylinder complimentary to the power shaft proximal end. The distal end of the power shaft may be operable to receive a transmission system and transfer the rotation of the piston rotor to enable the transfer of power into mechanical work.

The intake system may include an intake manifold for delivering the fuel (e.g., an air fuel mixture) to the intake valve associated with each cylinder. The intake manifold may take the form of a tubular ring chamber positioned at predetermined radius relative to the power shaft and may be in alignment with the intake ports and valves for the cylinders. The ring chamber may have a substantially circular cross-section. In some embodiments (e.g., embodiments in which conventional gasoline is used as the fuel), the ring chamber may include a receiving channel along its entire length on an opposite side thereof from the cylinder rotor. The receiving channel may be configured to receive a throttle ring having a complementary shape to that of the receiving channel such that the throttle ring can be adjustably nested within the receiving channel. An adjustable gap may be present between the throttle ring and the receiving channel for allowing air to flow into the ring chamber to provide the air in the air-fuel mixture. The throttle control of the engine may adjust the proximity of the throttle ring in order to adjust the choke of the engine. The air may be provided by an air conduit into the area of the intake system. The throttle ring may be in static position relative to the cylinder rotor with the gap between the receiving channel and the throttle ring allowing for the rotation of the ring chamber, while the throttle ring remains static. In other embodiments, the engine can be used with other types of fuel, such as alcohol, methane, propane, other natural gas-based fuels, diesel, hydrogen, and other appropriate fuels. Adjustments to the fuel delivery system may be made for such fuels.

In some embodiments, a series of intake runners may be attached to the throttle rings chamber. There may be an independent intake runner that corresponds to each cylinder in the engine. The intake runners enable the intake manifold to have a placement above the system's valve train away from the combustion chamber. The intake runners may have a catch within the intake manifold to catch the combustible fuel and air mixture. The catch may be ported to provide a fluid transfer of fuel. The intake runner may deliver fuel to the head of the corresponding cylinder.

The throttle ring may be attached to the motor frame via biased connections that bias the throttle ring toward the closed position. For example, the throttle ring may be connected to the motor frame via studs and biasing springs biasing the throttle ring toward the closed position. The studs may include stops that prevent the throttle ring from contacting the receiving channel of the ring chamber, preventing full choke and seizing between the throttle ring and the ring chamber. The engine may have a throttle control in mechanical connection with the throttle ring, allowing an operator to adjust the proximity of the throttle ring to the ring chamber, and thereby adjust the choke of the engine.

In some embodiments, the throttle ring may attach to the motor frame via a series of roller pins positioned orthogonally to the throttle ring's top surface. The pins may attach to the motor frame with a cammed collar that is concentrically fixed to the frame. The cammed collar may have a plurality of slots complementary to each of the roller pins and may be equidistantly positioned around the collar. The slots provide a path for the pins to follow. In some embodiments, the slots may provide a substantially oscillating, curved, or helical path. When the throttling ring is actuated the pins may guide the throttle ring along the slot path (e.g., a curved path) thereby translating and rotating the throttle plate around the cammed collar. For example, the roller pins may slide up the cammed collar and control the translation and rotation of the throttle ring to a specific position that corresponds to the engine's rotational speed and the air-fuel ratio necessary for combustion. A throttle control mechanism may be a throttle cable and pulley system that allows an operator to adjust the throttle ring's actuation to a specific position. A pulley and cable system may have a pulley tensioner to adjust the throttle ring and ring chamber, thereby adjusting the engine's choke. In some embodiments, an electrical actuation of the system may be utilized. The intake and air fuel ratio may be regulated by various sensors such as an oxygen sensor (e.g., O₂ sensor), electronic fuel injection (e.g., E.F.I.) and high energy ignition system (e.g. H.E.I.). In some embodiments a slipping may be incorporated at some location on the cylinder rotor to prevent tangling of electrical wiring.

A fuel injector may be connected to the throttle ring for passing fuel into the ring chamber. The fuel injector may be positioned over the point at which the intake valve is opened during the intake stroke and the intake port is exposed allowing the passage of the fuel (e.g., an air-fuel mixture) through the intake port. The fuel injector may be timed to spray fuel into the ring chamber as the intake valve opens, allowing fuel (e.g., the air-fuel mixture) through the intake port and into the open cylinder.

In some embodiments, there may be a plurality of fuel injectors on the throttle ring to provide suitable fuel to the system. The array of fuel injectors may be fired simultaneously or independently depending on the speed or air-fuel ratio requirements for efficient combustion. For example, three fuel injectors may be secured to the throttle ring and positioned to align with the intake runner catch during the intake stroke. At low speeds where less fuel is required, only one injector may be enabled, and at higher speeds, the additional injectors may be activated to provide fuel. In another embodiment, the fuel injectors may be position on the intake runners and may be timed to fired when the system intake stroke begins. In another embodiment, the injectors may be positioned on the throttle ring such that when the throttle is increased the injectors are positioned directly above the intake runners.

Air may be introduced into the intake system through the gap between the throttle ring and the ring chamber via passages in the engine housing around the intake system. The passages may be located in the engine housing peripherally to the side of the cylinder rotor that faces away from the central plane where the pistons and cylinders meet. The passages may circulate cooling air drawn into the engine housing. For example, and without limitation, the air may be drawn into passages through the housing positioned axially of each cylinder block and discharged through apertures through the housing positioned radially on housing. In some embodiments, the passages may include fins and slots are formed in the passages to impart rotation and/or direct flow of the air.

An intake valve may control the passage of the air-fuel mixture through the intake port into the corresponding cylinder during the intake stroke. In some embodiments, the intake valve may be operated and opened by negative pressure during the intake stroke, and the intake valve may remain closed during the other stages of the combustion cycle. In some embodiments, the low pressure generated in the cylinder during the intake stroke may be sufficient to open an intake valve for the cylinder to allow the entry of the fuel. The intake valve may include a seated structure in the intake port that is held in the seated position by a biasing device, such as a spring that biases the structure to the closed position. The force applied by the biasing device to the valve structure may be overcome by the vacuum in the cylinder during the intake stroke. The valve structure may be a poppet valve structure with a corresponding spring. In some examples, the valve head may be nested in the intake port, such that it does not interfere with other parts of the engine. In other embodiments, each cylinder may have an intake valve actuated by a mechanical timing mechanism operable to open the valve.

An exhaust valve may control the passage of the exhaust gas through the exhaust port into an exhaust conduit during the exhaust stroke. The exhaust valve may be operated and opened by a cam system that is in mechanical connection with the rotating cylinder rotor, e.g., through a gearing system that times the cam such that it opens the exhaust valve at the exhaust stroke for the corresponding cylinder. In some embodiments, the cam system may include gearing with a ratio that allows it to spin at half of the rotational speed of the cylinder rotor. In such embodiments, the cam system may include a drum that rotates in the same direction as the power shaft at one half the rotational speed of the cylinder rotor, and may turn freely with respect to the power shaft on a bearing. In such embodiments, four cam lobes may protrude from the drum to engage the valve push rods or other engagement structures of the exhaust valves of each of the paired pistons and cylinders. The cams may be structured such that a cam opens the exhaust valve for a particular cylinder when the corresponding piston is at bottom dead center and keeps the exhaust valve open until the corresponding piston reaches top dead center (e.g., the cam lobe may have a length of nearly about ¼ of the circumference of the drum). The cam drum may be rotated by a gearing system that accomplishes rotational speed that is one half of the speed of the cylinder rotor. The combination of the about ¼ turn cam lobes and the ½ ratio of cam drum rotation to cylinder rotor rotation allows for the exhaust valve to be open for the most to about all of the exhaust stroke, since the about ¼ turn length of the cam lobe engages the exhaust valve while the cylinder valve rotates 180°. The cam lobes may be staggered along the axial dimension of the drum and the exhaust valve push rods may be correspondingly staggered such that each cam lobe only engages with the exhaust valve of a particular cylinder, allowing the exhaust valves to remain closed during the other stages of the combustion cycle.

### Independent Cylinder Head and Valve Train

In some embodiments, there may be a valve train operable to actuate an intake valve for providing a passage of fuel and air to the combustion chamber and an exhaust valve in the head for providing passage to expel exhaust from the system. For each cylinder in the engine, a valvetrain may include an independent camshaft, a timing shaft, and independent valves for exhaust and intake. Each shaft may have a neutral axis at an orthogonal position about the cylinder rotor's central axis. The independent camshaft may have cam lobes in fluid connection with the system's valves (e.g., intake and exhaust). For each of the independent camshafts, a cylinder head may include, intake and exhaust ports, a valve seat for both the exhaust and intake valves, a camshaft cap, and supports operable to secure the camshaft and timing shaft. The cylinder head may secure to the cylinder rotor and concentrically seal the combustion chamber. Bearings attach concentrically to the shaft supports and may enable camshaft and timing shaft rotation. In manufacturing a bearing of various types may be used, but a ceramic thrust bearing may be ideal due to centrifugal forces from rotation of the system. The cylinder head may have two camshaft supports, one axial support adjacent to the rotor's circumference with suitable clearance, and one simple support adjacent to the cylinder head and nearest to the central axis of the cylinder rotor. The timing shaft may be axially supported to the camshaft cap and parallel to the camshaft's simple support and have a distance suitable for clearance of shaft components.

The valve train may be timed from a plurality of meshed gears secured to the exhaust shaft and rotated by the cylinder rotor's rotation. A control gear may have a series of gear teeth (e.g., beveled teeth) and may be fixed to the frame, providing a stationary guide for the timing of each of the gears in the cam valve train. A timing shaft may have a fan gear (e.g., timing gear) operable to mesh with the control gear, and may have a spur gear (e.g., reduction gear) immediately adjacent to the fan gear on the same shaft. The fan gear may be operable to reduce the rotation rate of the timing gear. The fan gear may mesh with a camshaft gear that is axially secured to the shaft simple support. The camshaft may have two cam lobes, one for an exhaust valve and another for an intake valve. The cam lobes may be of the form-closed type, where the cam provides a groove (e.g., track) operable to receive a roller (e.g., bearing pin) orthogonally affixed to a follower; this cam-type may provide a function to both push and pull the follower for translation in the cycle. The follower may be a valve slider connected (e.g., welded, threaded, etc.) to a valve lash compensator, and the valve lash compensator may connect the intake valve. The valve lash compensator may have threading to receive the valve slider and may have a disk spring therebetween and is secured with a retention ring to a proximal end of the compensator. On the compensator's distal end, an additional disc spring is secured within a coupler. The exterior of the coupler may have threading operable to receive and secure a valve stem. This system may not require a spring to return the valve to the closed position. In some examples, the valve structure may be a poppet valve structure with a valve stem and disk structure that may seat with the cylinder's head. The cylinder may have a bore sized to receive a valve guide that may concentrically secure the valve stem. During operation of the engine the cylinder rotor may rotate around the exhaust shaft, and each of the timing gears may rotate around the control gear. The timing gear's rotation is reduced between the reduction gear and the cam gear such that for every two rotations of the cylinder head, one full cycle of the valve train is completed to correspond with a four stroke engine cycle.

The cylinders heads may have an intake port position centrally within an intake flange operable to receive the intake runner. The intake flange may be position on the side wall of the cylinder head, having a central plane tangent to central axis of the cylinder rotor and the intake port central axis may have an oblique conduit angle with respect to the cylinder rotor's plate. The exhaust port may be positioned in the cylinder head and may have an exhaust flange operable to receive an exhaust manifold (e.g., tube). The exhaust flange may be position orthogonal to the central axis of the rotor and the central axis of the cylinder head. The exhaust manifold may have a flange on one end that may be fastened to the exhaust flange and may be sealed to the cylinder rotor shaft with an expandable gasket. In some embodiments, a cylinder heads proximal surface between the intake ports and valve train may receive an oil basin separator that is operable to contain oils and lubricants in the gearing system and shafts.

An exhaust conduit may be connected to each of the cylinders for passing the exhaust gas to an exhaust manifold that delivers the exhaust gas into an exhaust collection pipe. In some embodiments, the exhaust manifold may be incorporated into the power shaft, where each of the exhaust conduits routes from the exhaust port of the corresponding cylinder radially inward toward the power shaft. The exhaust conduits may connect with an exhaust manifold, which may be a cylindrical collar around the power shaft at or near the cylinder rotor. The exhaust conduits may connect with a port in the exhaust manifold that is in fluid connection with an exhaust pipe that rotates with the power shaft. In some embodiments, the exhaust pipe may be nested within the power shaft.

In some embodiments, where the cylinder rotors shaft does not provide power to a transmission system. The exhaust tube may be nested concentrically in the shaft, and a cooling insert may be placed between the exhaust tube and the shaft. The exhaust tube, shaft, and cooling insert may all have an exhaust conduit aligned with the exhaust manifold seal. The cooling insert may be a cylinder having an interior shell with channels for routing coolant through the shell to prevent heat transfer of the exhaust gases to the valve train environment and intake manifold. The cooling insert may have a hot flange and cold flange operable to send and receive coolant from a pump. The exhaust tube, shaft, and cooling inserts may all have the same length spanning from the combustion chamber exhaust port to the exhaust tubes flange.

The engine may include a support shaft for the piston rotor as well, which may be mounted to the engine block and allow the piston rotor to freely spin as the engine operates. IN some embodiments the piston rotor may be engaged with other elements of the engine or other systems (e.g., a battery charging system, fan systems, etc.) to utilize the energy provided by the rotation of the piston rotor. For example, the piston rotor may be connected to a rotating shaft that nests in the support shaft and passes through the engine housing to the exterior of the engine housing to allow for direct or geared attachment to provide power for another system.

The engine may include an oil pump for providing lubrication to the engine. The oil pump may include a spraying mechanism that delivers oil into the area of the pistons and cylinders to lubricate the structures as they rotate. The spraying mechanism may provide a large volume of oil into the area of the pistons and rotors. For example, and without limitation, the oil pump may draw oil from a sump located at the center of the engine housing and below the pistons and cylinders and the spraying mechanism may be positioned to deliver oil upwards against a cowling in the engine housing and into the area of the pistons and cylinders. The cowling may include grooves into which the oil is delivered that allow for limited retention of the sprayed oil to facilitate thermal transfer between the oil and the wall of the engine housing. The cowling may comprise a highly conductive metal, such as aluminum, aluminum alloys, and other highly conductive materials. To further facilitate thermal transfer, the engine housing may include cooling fins on the exterior thereof in close proximity to the cowling to allow heat to radiate therefrom. The engine may also include a fan system that provides air to the area of the cooling fins.

The paired rotor design of the present invention may be included in other types of devices and applied to other functions. For example, in some embodiments, the presently disclose rotor arrangement may be incorporated into a pumping system. Such a pumping system may use the reciprocal action of the pistons and cylinders to pressurize and pump fluids (e.g., gases such as oxygen gas, hydrogen gas, etc., liquids such as water, lubricants, effluent, etc.) into a system operable to utilize such fluids. Such a pumping system may include cylinder and piston rotors positioned at an oblique angle relative to one another (e.g., in a range of about 120° to about 160°) with their respective pistons and cylinders extending orthogonally or substantially orthogonally from the rotors and meeting at a central plane (e.g., a vertical plane) that may be a pre-determined distance between the cylinder and piston rotors. For example, the central plane may be equidistant from the piston rotor and the cylinder rotor. In some embodiments the angle of the cylinder and piston rotors may be the same relative to the central plane. In other embodiments, the respective angles of the cylinder and piston rotors may be different, but may not vary from each other by more than about 5°. The angled arrangement of the cylinder and piston rotors creates an oscillating distance between corresponding piston heads and cylinders as the cylinder and piston rotors synchronously rotate. The cylinders may be fixedly connected to the cylinder rotor in an orthogonal or substantially orthogonal orientation. The cylinders may be positioned in various arrangements, which correspond to the arrangement of the piston rods on the piston rotor. For example, and without limitation, the cylinders may include three cylinders in a triangular pattern, four cylinders in a square pattern, five cylinders equidistantly arranged around the perimeter of the cylinder rotor, six cylinders arranged equidistantly around the perimeter of the cylinder rotor, and other arrangements. The piston rods may be arranged in a corresponding pattern on the piston rotor. The piston rotor may have piston rods connected thereto in various arrangements, but one that corresponds to the arrangement of cylinders on the cylinder rotor. For example, and without limitation, the piston rods may include three rods in a triangular pattern, four rods in a square pattern, five rods equidistantly arranged around the perimeter of the piston rotor, six rods arranged equidistantly around the perimeter of the piston rotor, and other arrangements. With a greater number of piston and piston chamber combinations the more fluid can be provided by the pumping system per rotation of the rotors.

As discussed with respect to other embodiments, the piston heads may be connected to the piston rod by movable joints. To accommodate the angled arrangement of the piston rotor and the cylinder rotor, the piston heads may be connected to the rods by a movable joint, such as a ball joint to allow 360° rotation with two degrees of freedom relative to the ball joint. The angling of the piston rod relative to the cylinder axis may be limited to about 30° or less within a limited angle range relative to the central axis of the corresponding cylinder (e.g., within a cone having an apex angle of 30° or less) allowing limited movement to accommodate the geometry of the piston cylinder. Other similar mechanical connections between the piston head and piston rod are contemplated within the scope of the present invention as well. The moveable joint may allow for the piston heads reciprocate in and out of the cylinder with sufficient clearances between the piston rods and the walls of the cylinders without interference or seizing. The piston rods may be connected to the piston rotor by either fixed connection or movable joints, as discussed herein. The angled arrangement of the piston rotor and the cylinder rotor and the joints between the piston rods and piston heads may allow for the pistons to be fixed to the piston rotor in an orthogonal manner, with sufficient clearances between the piston rods and the walls of the cylinders without interference or seizing. In other examples, and without limitation, the piston rods may be connected by a movable joint. In one example, the piston rod may be connected to the rod rotor by a pivoting joint with one degree of freedom (e.g., a hinge joint), which may allow for some limited shifting of the piston rod (e.g., inward and outward relative to the center of the piston rotor) to accommodate the geometry of the corresponding piston chamber. This allows the piston rotor to rotate in unison with the cylinder rotor. In other embodiments, other joints such as a ball joint or a universal joint may be used in combination with extending the piston shaft and the cylinder into the center between both rotors and adding a universal joint at the angle where both shafts meet. This arrangement will also allow both rotors to turn in unison.

In another example, the piston rods may each be connected to the piston rotor by a ball joint to allow 360° rotation two degrees of freedom relative to the ball joint. The angling of the piston rod relative to the piston rotor may be limited to about 10° or less within a limited angle range (e.g., within a cone having an apex angle of 10° or less) allowing limited movement to aid in accommodating the geometry of the piston chamber. Other similar mechanical connections between the piston rod and the piston rotor are contemplated within the scope of the present invention as well.

The cylinder rotor may be in mechanical connection with a drive shaft that rotates either the piston rotor or cylinder rotor to drive the rotation and reciprocal motion of the pistons and cylinders to thereby pump fluid from the cylinders into an exit (exhaust) conduit to deliver the fluid to a system that utilizes the fluid. The drive shaft may be fixedly connected to the rotor such that they rotate together at the same rotational velocity. The cylinder rotor may include exit (exhaust) ports to expel the fluid into the exit conduits. Each cylinder may have at least one exit port in the cylinder rotor (e.g., at the top of the cylinder).

The apparatus may also include an intake system delivering fluid into the chambers. The intake system may include intake ports or valves for intake of the fluid into the chambers. The intake system may also include an intake manifold for delivering the fluid to an intake valve or port associated with each cylinder. The intake manifold may take the form of a tubular ring chamber positioned at predetermined radius relative to the drive shaft and may be in alignment with the intake ports and valves for the cylinders. Both the intake and exhaust systems may also be positioned on the cylinder rotor such that they rotate with the cylinder rotor.

In some embodiments, the apparatus may include exit (exhaust) valves to control the passage of the fluid through the exit port into an exit (exhaust) conduit. The exit valve may be operated and opened by a cam system that is in mechanical connection with the rotating cylinder rotor, e.g., through a gearing system that times the cam such that it opens the exit valve when the piston head is fully or substantially fully inserted into the cylinder. In such embodiments, the cam system may include a drum that rotates in the same direction as the drive shaft (e.g., at the same rotational speed as the cylinder rotor), and may turn freely with respect to the drive shaft on a bearing. In such embodiments, four cam lobes may protrude from the drum to engage the valve push rods or other engagement structures of the exit valves of each of the paired pistons and cylinders. The cams may be structured such that a cam opens the exit valve for a particular cylinder when the corresponding piston is at bottom dead center and keeps the exit valve open until the corresponding piston reaches top dead center (e.g., the cam lobe may have a length of nearly about ¼ of the circumference of the drum). The cam drum may be rotated by a gearing system that accomplishes rotational speed that is one half of the speed of the cylinder rotor. The cam lobes may be staggered along the axial dimension of the drum and the exit valve push rods may be correspondingly staggered such that each cam lobe only engages with the exit valve of a particular cylinder, allowing the exit valves to remain closed during the other stages of the combustion cycle.

An exit conduit may be connected to each of the cylinders for passing the exit gas to an exhaust manifold that delivers the fluid into a fluid collection pipe. In some embodiments, the exhaust manifold may be incorporated into the drive shaft, where each of the exit conduits routes from the exit port of the corresponding cylinder radially inward toward the drive shaft. The exit conduits may connect with an exhaust manifold, which may be a cylindrical collar around the drive shaft at or near the cylinder rotor. The exit conduits may connect with a port in the exhaust manifold that is in fluid connection with an exit pipe that rotates with the drive shaft. In some embodiments, the exit pipe may be nested within the drive shaft.

It is an object of the invention to provide a rotary engine design that increases the efficiency of combustion engines. It is a further object of the present invention to provide apparatuses having pairs of rotating angled pistons and cylinders to create reciprocal motion that can be used in internal combustion engines, pumps, and other applications. Additional aspects and objects of the invention will be apparent from the detailed descriptions and the claims herein.

In one aspect, the present invention relates to a rotary engine, comprising a piston rotor having a plurality of pistons thereon and positioned on a first rotational axis; a cylinder rotor having a plurality of cylinders thereon and positioned on a second rotational axis; and a power shaft for transmitting rotational motion from one of the piston rotor and cylinder rotor to a transmission system for providing mechanical power to another system, where the first rotational axis and the second rotational axis are oblique relative to one another, and each of the plurality of pistons is nested in one of the plurality of cylinders and the rotation of the piston rotor and the cylinder rotor is driven by combustion of a fuel in the cylinders. The first and second rotational axes may be positioned on a same plane. The angle between the first rotational axis and the second rotational axis may be in a range of about 120° to about 160°. The pistons may each include a piston head connected to a piston rod by a movable joint. The movable joint may be a ball joint. The piston rod may be connected to the piston rotor by a movable joint. The piston rod may be fixedly attached to the piston rotor. The piston rod may be substantially orthogonal to the surface of the piston rotor. Due to the angle of the relative angle of the piston rotor and the cylinder rotor, synchronous rotation of the piston rotor and the cylinder rotor may result in a reciprocating motion of each piston within the corresponding cylinder, where the piston head of each piston penetrates furthest into the corresponding cylinder at a proximal point in its rotational path that is nearest to the cylinder rotor and the piston is at its most retracted point in the corresponding cylinder at a distal point in its rotational path that is furthest from the cylinder rotor. The combustion may occur at or near the proximal point. The piston head may be at top dead center at the proximal point. The intake may occur at or near the distal point. The piston head may be at bottom dead center at the distal point. The engine may be a four-stroke engine and the combustion cycle may be completed in two full rotations of the piston rotor and the cylinder rotor. Each stroke of the combustion cycle may occur over a 180° turn of the piston rotor and cylinder rotor.

The engine may further include a fuel intake system comprising an intake manifold and a throttle mechanism. The intake manifold may include a tube that is connected to the cylinder rotor and rotates with the cylinder rotor. The tube may have a substantially circular cross-section and has a ring shape that is concentric with the cylinder rotor and includes fuel delivery passages that are in fluid communication with each of the plurality of cylinders in the cylinder rotor. The tube may include a channel that runs the entire length of the tube on the side of the tube opposite from the cylinder rotor. The engine may further include a throttle system that includes throttle ring having a cross-sectional shape that is complementary to the channel in the tube, and a throttle control that is operable to move the throttle ring in and out of the channel to adjust the amount of allowed to flow into the tube. The engine may further include a fuel injector for injecting fuel into the tube, wherein the fuel injector is connected to the throttle ring and is positioned to inject fuel directly into the tube. The throttle ring and the fuel injector are stationary with respect to the cylinder rotor and the tube. Each of the plurality of cylinders may include an intake valve in fluid communication with the tube, and is opened by the vacuum created by an intake stroke of a corresponding piston.

The engine may further include an exhaust system comprising an exhaust manifold and an exhaust valve timing mechanism. Each of the plurality of cylinders includes an exhaust valve in fluid communication with the cylinder an exhaust conduit, wherein the exhaust conduit is in fluid communication with the exhaust manifold. The exhaust manifold may be mounted on the power shaft and rotates with the power shaft. The exhaust conduits may be connected to the cylinder rotor and rotate with the cylinder rotor. The exhaust conduits may connect ports in the exhaust manifold that are in fluid communication with an exhaust pipe that routes exhaust out of the engine. The exhaust pipe may rotate with the power shaft. The exhaust pipe may be nested in the power shaft. The exhaust valve timing system may include a cam drum that rotates independently of the power shaft. The cam drum may be in direct mechanical communication with the cylinder rotor via a gearing system that rotates the cam drum at a pre-determined speed relative to the cylinder rotor. The cam drum may include at least one cam for actuating the exhaust valve of each of the plurality of cylinders, wherein the at least one cam actuates the exhaust valve of each of the plurality of cylinders during exhaust stroke.

In a second aspect, the present invention relates to a rotary engine, comprising a piston rotor having a plurality of pistons thereon and positioned on a first rotational axis; and a cylinder rotor having a plurality of cylinders thereon and positioned on a second rotational axis, wherein the first rotational axis and the second rotational axis are oblique relative to one another, and each of the plurality of pistons is nested in one of the plurality of cylinders and the rotation of the piston rotor and the cylinder rotor is driven by combustion of a fuel in the cylinders. The engine may further include a power shaft for transmitting rotational motion from one of the piston rotor and cylinder rotor to a transmission system for providing mechanical power to another system. The first and second rotational axes may be positioned on a same plane. The angle between the first rotational axis and the second rotational axis may be in a range of about 120° to about 160°. The pistons may each include a piston head connected to a piston rod by a movable joint. The movable joint may be a ball joint. The piston rod may be connected to the piston rotor by a movable joint. The piston rod may be fixedly attached to the piston rotor. The piston rod may be substantially orthogonal to the surface of the piston rotor. Due to the angle of the relative angle of the piston rotor and the cylinder rotor, synchronous rotation of the piston rotor and the cylinder rotor may result in a reciprocating motion of each piston within the corresponding cylinder, where the piston head of each piston penetrates furthest into the corresponding cylinder at a proximal point in its rotational path that is nearest to the cylinder rotor and the piston is at its most retracted point in corresponding cylinder at a distal point in its rotational path that is furthest from the cylinder rotor. The combustion may occur at or near the proximal point. The piston head may be at top dead center at the proximal point. The intake may occur at or near the distal point. The piston head may be at bottom dead center at the distal point. The engine may be a four-stroke engine and the combustion cycle may be completed in two full rotations of the piston rotor and the cylinder rotor. Each stroke of the combustion cycle may occur over a 180° turn of the piston rotor and cylinder rotor.

The engine may further include a fuel intake system comprising an intake manifold and a throttle mechanism. The intake manifold may include a tube that is connected to the cylinder rotor and rotates with the cylinder rotor. The tube may have a substantially circular cross-section and has a ring shape that is concentric with the cylinder rotor and includes fuel delivery passages that are in fluid communication with each of the plurality of cylinders in the cylinder rotor. The tube may include a channel that runs the entire length of the tube on the side of the tube opposite from the cylinder rotor. The engine may further include a throttle system that includes throttle ring having a cross-sectional shape that is complementary to the channel in the tube, and a throttle control that is operable to move the throttle ring in and out of the channel to adjust the amount of allowed to flow into the tube. The engine may further include a fuel injector for injecting fuel into the tube, wherein the fuel injector is connected to the throttle ring and is positioned to inject fuel directly into the tube. The throttle ring and the fuel injector are stationary with respect to the cylinder rotor and the tube. Each of the plurality of cylinders may include an intake valve in fluid communication with the tube, and is opened by the vacuum created by an intake stroke of a corresponding piston.

The engine may further include an exhaust system comprising an exhaust manifold and an exhaust valve timing mechanism. Each of the plurality of cylinders includes an exhaust valve in fluid communication with the cylinder an exhaust conduit, wherein the exhaust conduit is in fluid communication with the exhaust manifold. The exhaust manifold may be mounted on the power shaft and rotates with the power shaft. The exhaust conduits may be connected to the cylinder rotor and rotate with the cylinder rotor. The exhaust conduits may connect ports in the exhaust manifold that are in fluid communication with an exhaust pipe that routes exhaust out of the engine. The exhaust pipe may rotate with the power shaft. The exhaust pipe may be nested in the power shaft. The exhaust valve timing system may include a cam drum that rotates independently of the power shaft. The cam drum may be in direct mechanical communication with the cylinder rotor via a gearing system that rotates the cam drum at a pre-determined speed relative to the cylinder rotor. The cam drum may include at least one cam for actuating the exhaust valve of each of the plurality of cylinders, wherein the at least one cam actuates the exhaust valve of each of the plurality of cylinders during exhaust stroke.

In a third aspect, the present invention relates to mechanical apparatus comprising a piston rotor having a plurality of pistons thereon and positioned on a first rotational axis; and a cylinder rotor having a plurality of cylinders thereon and positioned on a second rotational axis, wherein the first rotational axis and the second rotational axis are oblique relative to one another, and each of the plurality of pistons is nested in one of the plurality of cylinders. The first and second rotational axes may be positioned on a same plane. The angle between the first rotational axis and the second rotational axis may be in a range of about 120° to about 160°. The pistons may each include a piston head connected to a piston rod by a movable joint. The movable joint may be a ball joint. The piston rod may be connected to the piston rotor by a movable joint. The piston rod may be fixedly attached to the piston rotor. The piston rod may be substantially orthogonal to the surface of the piston rotor. Due to the angle of the relative angle of the piston rotor and the cylinder rotor, synchronous rotation of the piston rotor and the cylinder rotor results in a reciprocating motion of each piston within the corresponding cylinder, wherein the piston head of each piston penetrates furthest into the corresponding cylinder at a proximal point in its rotational path that is nearest to the cylinder rotor and the piston is at its most retracted point in corresponding cylinder at a distal point in its rotational path that is furthest from the cylinder rotor. The apparatus may further include a fluid intake system comprising an intake manifold. The apparatus may further include a fluid exhaust system comprising an exhaust manifold. Each of the plurality of cylinders may include an exhaust passage in fluid communication with an exhaust conduit, wherein the exhaust conduit is in fluid communication with the exhaust manifold. The exhaust conduits may be connected to the cylinder rotor and rotate with the cylinder rotor. The exhaust conduits may connect ports in the exhaust manifold that are in fluid communication with a fluid exhaust conduit that routes fluid out of the apparatus.

In a fourth aspect, the present invention relates to a method of generating propulsive force, comprising positioning a plurality of pistons connected to a piston rotor positioned on a first rotational axis in a plurality of cylinders positioned on a cylinder rotor positioned on a second rotational axis to form a plurality of paired pistons and cylinders, wherein the first rotational axis and the second rotational axis are oblique relative to one another; and combusting a fuel in the paired pistons and cylinders in a sequential pattern to drive rotation of the piston rotor and the cylinder rotor, wherein the rotation of one of the piston rotor and the cylinder rotor drives rotation of a power shaft for transmitting rotational motion from one of the piston rotor and cylinder rotor to a transmission system for providing mechanical power to another system. The first and second rotational axes may be positioned on a same plane. The angle between the first rotational axis and the second rotational axis may be in a range of about 120° to about 160°. The pistons may each include a piston head connected to a piston rod by a movable joint. The movable joint may be a ball joint. The piston rod may be connected to the piston rotor by a movable joint. The piston rod may be fixedly attached to the piston rotor. The piston rod may be substantially orthogonal to the surface of the piston rotor. Due to the angle of the relative angle of the piston rotor and the cylinder rotor, synchronous rotation of the piston rotor and the cylinder rotor may result in a reciprocating motion of each piston within the corresponding cylinder, where the piston head of each piston penetrates furthest into the corresponding cylinder at a proximal point in its rotational path that is nearest to the cylinder rotor and the piston is at its most retracted point in corresponding cylinder at a distal point in its rotational path that is furthest from the cylinder rotor. The combustion may occur at or near the proximal point. The piston head may be at top dead center at the proximal point. The intake may occur at or near the distal point. The piston head may be at bottom dead center at the distal point. The engine may be a four-stroke engine and the combustion cycle may be completed in two full rotations of the piston rotor and the cylinder rotor. Each stroke of the combustion cycle may occur over a 180° turn of the piston rotor and cylinder rotor.

The engine may further include a fuel intake system comprising an intake manifold and a throttle mechanism. The intake manifold may include a tube that is connected to the cylinder rotor and rotates with the cylinder rotor. The tube may have a substantially circular cross-section and has a ring shape that is concentric with the cylinder rotor and includes fuel delivery passages that are in fluid communication with each of the plurality of cylinders in the cylinder rotor. The tube may include a channel that runs the entire length of the tube on the side of the tube opposite from the cylinder rotor. The engine may further include a throttle system that includes throttle ring having a cross-sectional shape that is complementary to the channel in the tube, and a throttle control that is operable to move the throttle ring in and out of the channel to adjust the amount of allowed to flow into the tube. The engine may further include a fuel injector for injecting fuel into the tube, wherein the fuel injector is connected to the throttle ring and is positioned to inject fuel directly into the tube. The throttle ring and the fuel injector are stationary with respect to the cylinder rotor and the tube. Each of the plurality of cylinders may include an intake valve in fluid communication with the tube, and is opened by the vacuum created by an intake stroke of a corresponding piston.

The engine may further include an exhaust system comprising an exhaust manifold and an exhaust valve timing mechanism. Each of the plurality of cylinders includes an exhaust valve in fluid communication with the cylinder an exhaust conduit, wherein the exhaust conduit is in fluid communication with the exhaust manifold. The exhaust manifold may be mounted on the power shaft and rotates with the power shaft. The exhaust conduits may be connected to the cylinder rotor and rotate with the cylinder rotor. The exhaust conduits may connect ports in the exhaust manifold that are in fluid communication with an exhaust pipe that routes exhaust out of the engine. The exhaust pipe may rotate with the power shaft. The exhaust pipe may be nested in the power shaft. The exhaust valve timing system may include a cam drum that rotates independently of the power shaft. The cam drum may be in direct mechanical communication with the cylinder rotor via a gearing system that rotates the cam drum at a pre-determined speed relative to the cylinder rotor. The cam drum may include at least one cam for actuating the exhaust valve of each of the plurality of cylinders, wherein the at least one cam actuates the exhaust valve of each of the plurality of cylinders during exhaust stroke.

In a fifth aspect, the present invention relates to a method of fluid movement, comprising positioning a plurality of pistons connected to a piston rotor positioned on a first rotational axis in a plurality of cylinders positioned on a cylinder rotor positioned on a second rotational axis to form a plurality of paired pistons and cylinders, wherein the first rotational axis and the second rotational axis are oblique relative to one another; and moving a fluid through the paired pistons and cylinders in a sequential pattern, wherein the rotation of one of the piston rotor and the cylinder rotor results in movement of the fluid from the cylinders into an exhaust system. The first and second rotational axes may be positioned on a same plane. The angle between the first rotational axis and the second rotational axis may be in a range of about 120° to about 160°. The pistons may each include a piston head connected to a piston rod by a movable joint. The movable joint may be a ball joint. The piston rod may be connected to the piston rotor by a movable joint. The piston rod may be fixedly attached to the piston rotor. The piston rod may be substantially orthogonal to the surface of the piston rotor. Due to the angle of the relative angle of the piston rotor and the cylinder rotor, synchronous rotation of the piston rotor and the cylinder rotor may result in a reciprocating motion of each piston within the corresponding cylinder, wherein the piston head of each piston penetrates furthest into the corresponding cylinder at a proximal point in its rotational path that is nearest to the cylinder rotor and the piston is at its most retracted point in corresponding cylinder at a distal point in its rotational path that is furthest from the cylinder rotor.

The paired pistons and rotors may be incorporated into an apparatus that includes a fluid intake system comprising an intake manifold. The intake manifold includes a tube that may be connected to the cylinder rotor and rotates with the cylinder rotor. The tube may have a substantially circular cross-section and has a ring shape that is concentric with the cylinder rotor and includes fluid delivery passages that are in fluid communication with each of the plurality of cylinders in the cylinder rotor. The paired pistons and rotors may be incorporated into an apparatus that includes an exhaust system comprising an exhaust manifold and an exhaust valve timing mechanism. The plurality of cylinders may include an exhaust valve in fluid communication with the cylinder an exhaust conduit, wherein the exhaust conduit is in fluid communication with the exhaust manifold. The exhaust conduits may be connected to the cylinder rotor and rotate with the cylinder rotor. The exhaust conduits may connect to ports in the exhaust manifold that are in fluid communication with an exhaust pipe that routes fluid out of the apparatus.

In a sixth aspect, the present invention relates to a rotary engine, comprising a piston rotor having a plurality of pistons thereon and positioned on a first rotational axis; a cylinder rotor having a plurality of cylinders thereon and positioned on a second rotational axis; and a power shaft for transmitting rotational motion from one of the piston rotor and cylinder rotor to a transmission system for providing mechanical power to another system, where the first rotational axis and the second rotational axis are oblique relative to one another, and each of the plurality of pistons is nested in one of the plurality of cylinders and the rotation of the piston rotor and the cylinder rotor is driven by combustion of a fuel in the cylinders. The first and second rotational axes may be position on the same plane. The angle between the first rotation axis and the second rotational axis is in a range of about 120° to about 160°. The pistons may each include a piston head connected to a piston rod by a movable rod. The piston rod may connect to the piston rotor by a movable joint. The piston rod may be substantially orthogonal to the surface of the piston rotor. Due to the angle of the relative angle of the piston rotor and the cylinder rotor, synchronous rotation of the piston rotor and the cylinder rotor may result in a reciprocating motion of each piston within the corresponding cylinder; the piston head of each piston may penetrate furthest into the corresponding cylinder at a proximal point in its rotational path that may be nearest to the cylinder rotor and the piston may be at its most retracted point in the corresponding cylinder at a distal point in its rotational path that may be furthest from the cylinder rotor, and combustion may occur at or near the proximal point.

The engine of the present invention may include a plurality of independent cylinder heads positioned adjected to the cylinder rotor and concentric to each of said plurality of cylinders wherein the independent cylinder head includes a camshaft, an intake valve, an exhaust valve, an intake port for receiving an air fuel mixture, and an exhaust port for directing combustion products. The camshaft may have a neutral axis positioned orthogonal to the central axis of said cylinder rotor, an intake came may be fixed to the camshaft and position adjacent to the central axis of said intake valve, and an exhaust cam that may be fixed to the camshaft and position adjected to the central axis of the exhaust valve. Both the intake cam and exhaust cam may have an interior groove in fluid communication with a rotatable pin that may be secured to a valve retainer that may be perpendicularly positioned to a valve stems proximal point for each the intake valve and exhaust valve. The camshaft may be operable to translate the intake valve and exhaust valve to an open position and a closed position. The cam shaft may have a cam gear in synchronism with a valvetrain comprising a control gear in mesh with a timing gear, of which may be secured to a timing shaft having a reduction gear in mesh with the cam gear. The control gear may be concentrically positioned about the cylinder rotors rotational axis and may be fixed to a frame, and the timing shaft may be axially secured to the cylinder head in an orthogonal fashion.

The engine of the present invention may include a fuel intake system comprising an intake manifold, and a throttle mechanism, where the intake manifold may include a tube that may connect to the cylinder rotor and rotate with the cylinder rotor. The tube may have a substantially circular cross-section and may have a ring shape that is concentric with the cylinder rotor, and includes an intake runner in fluid communication with each intake port o the plurality of cylinder head in the cylinder rotor. Each of the plurality of cylinder head may have the intake valve in fluid communication with the intake port, and may be opened by the intake cam and vacuum created by the intake stroke of the corresponding piston head.

The engine of the present invention may include a exhaust system comprising and exhaust manifold, an exhaust shaft, and a cooling insert, wherein said exhaust manifold is in fluid communication with said exhaust port of said cylinder head and may be operable to direct combustion products from said cylinder upon translation of the exhaust valve. The exhaust shaft may include an exhaust conduit aligned with the exhaust manifold and may be aligned with an exhaust conduit of said colling insert for routing the combustion products to the exhaust tube. The cooling insert includes a cold side in contact with the exhaust shaft, a hot side in contact with the exhaust tube, and a passage operable to receive a thermal fluid operable to absorb heat and prevent excessive heat transfer to the exhaust shaft. The exhaust shaft may be concentrically aligned with the rotational axis of the cylinder rotor, and may be fixed to the cylinder rotor. The piston rotor may include the power shaft positioned concentrically to the piston rotors rotational axis. Finally, the engine of the present invention may include a stability shaft fixed to the piston rotor and may be secured to a movable joint at the rotational axis of the cylinder rotor, where the stability shaft is operable to freely rotate and stabilize the piston rotor.

### BRIEF DESCRIPTION OF THE DRAWINGS

FIG. 1 is a side view of an engine according to an embodiment of the present invention.

FIG. 2 is a cross-sectional view of an engine according to an embodiment of the present invention.

FIG. 3 is a perspective view of component systems of an engine according to an embodiment of the present invention.

FIG. 4A is a cross-sectional view of component systems of an engine according to an embodiment of the present invention.

FIG. 4B is a cross-sectional view of component systems of an engine according to an embodiment of the present invention.

FIG. 5 is a plan view of component systems of an engine according to an embodiment of the present invention.

FIG. 6 is a cross-sectional view of component systems of an engine according to an embodiment of the present invention.

FIG. 7 is a side view of an engine according to an embodiment of the present invention.

FIG. 8 is a cross-sectional view of an engine according to an embodiment of the present invention.

FIG. 9 is a perspective view of component systems of an engine according to an embodiment of the present invention.

FIG. 10 is a distal bottom view of component systems of an engine according to an embodiment of the present invention.

FIG. 11 is a cross-sectional side view of component systems of an engine according to an embodiment of the present invention.

### DETAILED DESCRIPTION

Reference will now be made in detail to certain embodiments of the invention, examples of which are illustrated in the accompanying drawings. While the invention will be described in reference to these figures and certain implementations and examples of the embodiments, it will be understood that such implementations and examples are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. References to various features of the “present invention” throughout this document do not mean that all claimed embodiments or methods must include the referenced features. It will be apparent to one skilled in the art that the present invention may be practiced without these specific details or features.

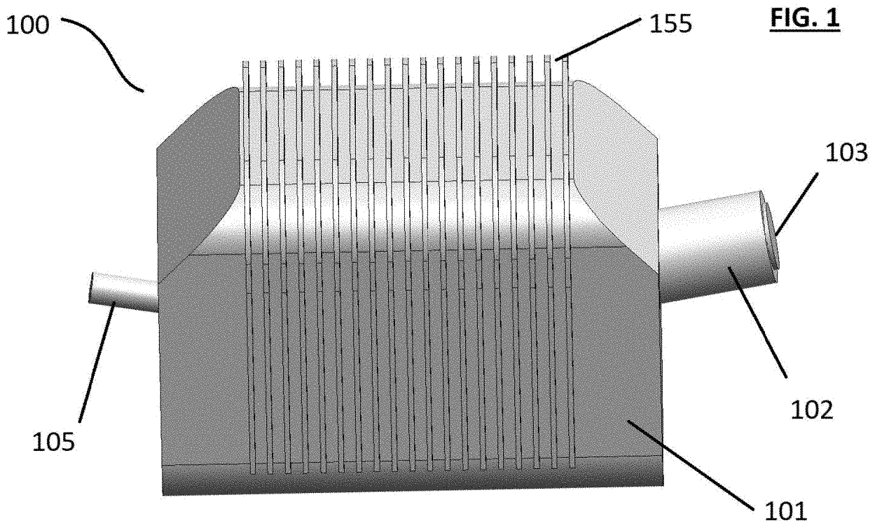

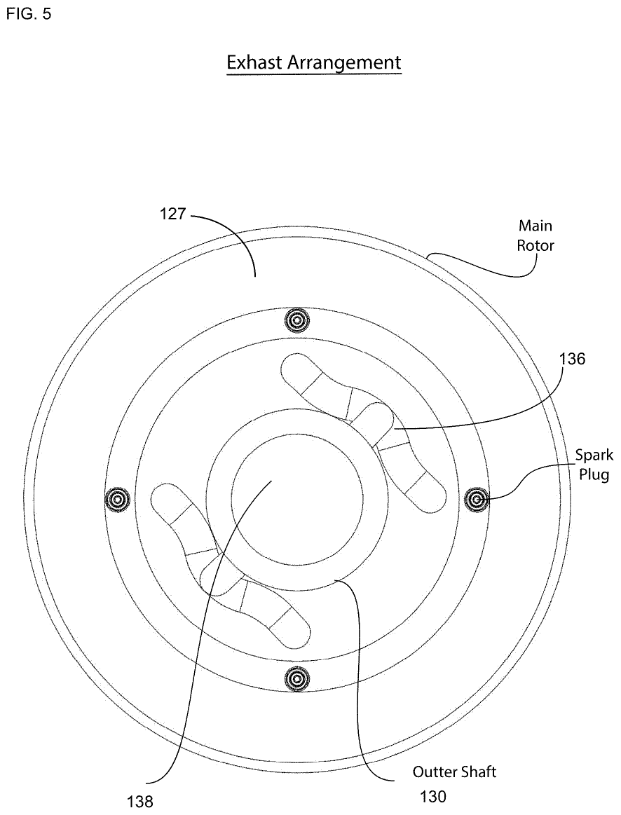

Reference will be made to the exemplary illustrations in the accompanying drawings, and like reference characters may be used to designate like or corresponding parts throughout the several views of the drawings. FIGS. 1-6 provide views of an exemplary embodiment of a novel internal combustion engine having a rotary piston and cylinder design.

The engine of the present invention provides a rotary cylinder and piston system that drives a power shaft to transmit power to a power transmission system for various uses, including powering an automobile, powering a generator, powering a pumping system, and other applications. The engine 100 may be enclosed in an engine housing 101, enclosing the cylinder and piston rotors, as well as other systems, such as the intake and exhaust systems. A power shaft 102 may traverse the engine housing 101 such that it may deliver power to a power transmission assembly (not shown), such as a vehicle transmission. An exhaust pipe 103 may be nested within the power shaft and may allow for the removal of combustion exhaust from the engine housing and may be routed to a venting system. The exhaust pipe 103 may rotate with the power shaft and connect with a stationary system in a downstream location. The power shaft 102 may be in mechanical connection with a cylinder rotor, such that the rotation of the cylinder rotor rotates the power shaft 102. An idler shaft 105 may be present to connect to and hold a piston rotor in position within the engine housing 101 to position the piston rotor in proper orientation relative to the cylinder rotor and allow for free rotation of the piston rotor. The engine 100 may also include an engine cooling system that includes an oil pump and delivery system that works in coordination with cooling fins 155 operable to absorb thermal energy from the interior of the engine 100 and radiate it to the ambient air.

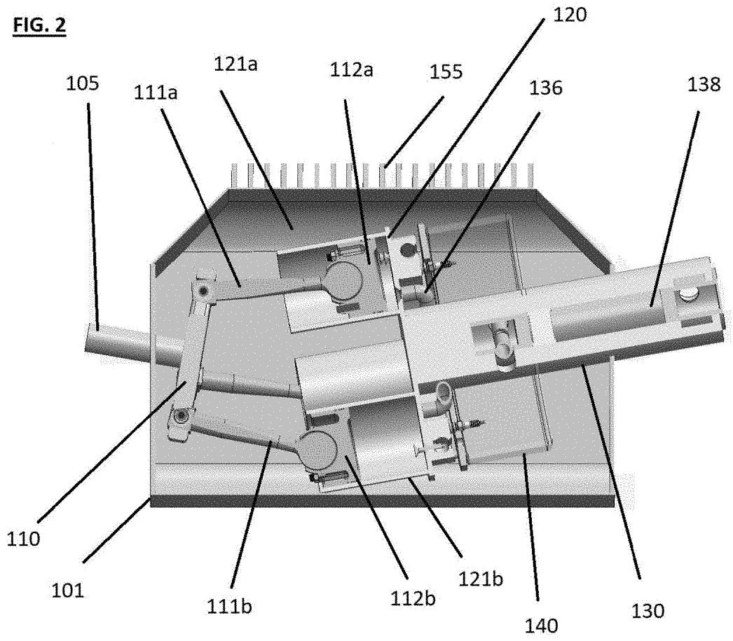

FIG. 2 provides a cross-sectional view of the engine 100 showing most of the major internal parts of the embodiment. The piston rotor 110 and cylinder rotor 120 are shown in profile positioned at an oblique angle relative to one another within the engine housing 101. The rotors meet at a central plane (e.g., a vertical plane) that may be a pre-determined distance between the cylinder rotor 120 and piston rotor 110. In the embodiment shown in the FIGS., the central plane may be equidistant from the piston rotor 110 and the cylinder rotor 120. The angles of the cylinder rotor 120 and piston rotor 110 may be the same relative to the central plane. The angled arrangement of the cylinder rotor 120 and the piston rotor 110 creates an oscillating distance between corresponding piston heads and cylinders as the cylinder and piston rotors synchronously rotate. As shown in FIG. 2, there are multiple pistons 111a and 111b connected to the piston rotor 110. The pistons 111a and 111b include piston heads 112a and 112b nested in cylinders 121a and 121b. At the top of the rotational path of the pistons and cylinders, where piston head 111a and cylinder 112a are positioned in FIG. 2, the piston head 112a is at top dead center. At this position, the cylinder rotor 120 and the piston rotor 110 are in their closest proximity and the piston head 112a is fully inserted into the corresponding cylinder 121a. As the paired cylinder 121a and piston 111a rotate away from top dead center, they progressively move apart until they reach the bottom of the rotational path 180° from top dead center (at bottom dead center), where piston 111b and corresponding cylinder 121b are positioned in FIG. 2. As the paired cylinder and piston rotate back toward the top of the rotational path, the piston and cylinder progressively move together.

As shown in FIG. 2, the cylinders 121 may be fixedly connected to a cylinder rotor 120 in an orthogonal or substantially orthogonal orientation. In the embodiment shown in the FIGS., the cylinders 121 may be positioned in a square arrangement of four cylinders with cylinders arranged equidistantly around the perimeter of the cylinder rotor 120. The piston rods of pistons 111 may be arranged in a corresponding pattern on the piston rotor 110. In the embodiment shown in the FIGS., the piston rods 112 may be connected to the piston rotor 110 by movable joints with one degree of freedom, for example a pivoting joint.

The piston heads 112a and 112b may be connected to the corresponding piston rods 111a and 111b by movable joints. To accommodate the angled arrangement of the piston rotor 110 and the cylinder rotor 120, the piston heads 112 may be connected to the rods by a movable joint, such as a ball joint to allow 360° rotation with two degrees of freedom relative to the ball joint. The angling of the piston rods 111 relative to the axes of the cylinders 121 may be limited to about 30° or less within a limited angle range relative to the central axis of the corresponding cylinder 121, allowing limited movement to accommodate the geometry of the piston cylinder 121. The moveable joint may allow for the piston heads 112 to reciprocate in and out of the corresponding cylinder 121 with sufficient clearances between the piston rods and the walls of the cylinders without interference or seizing.

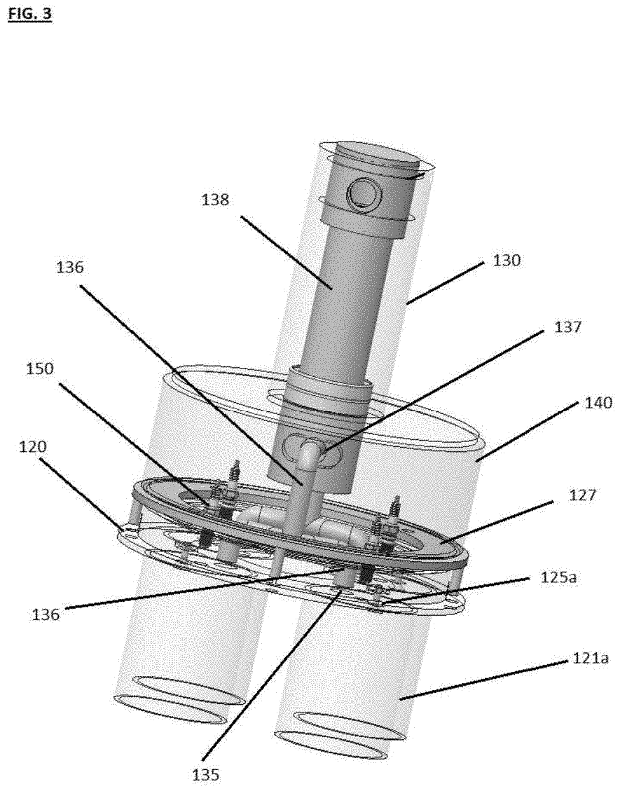

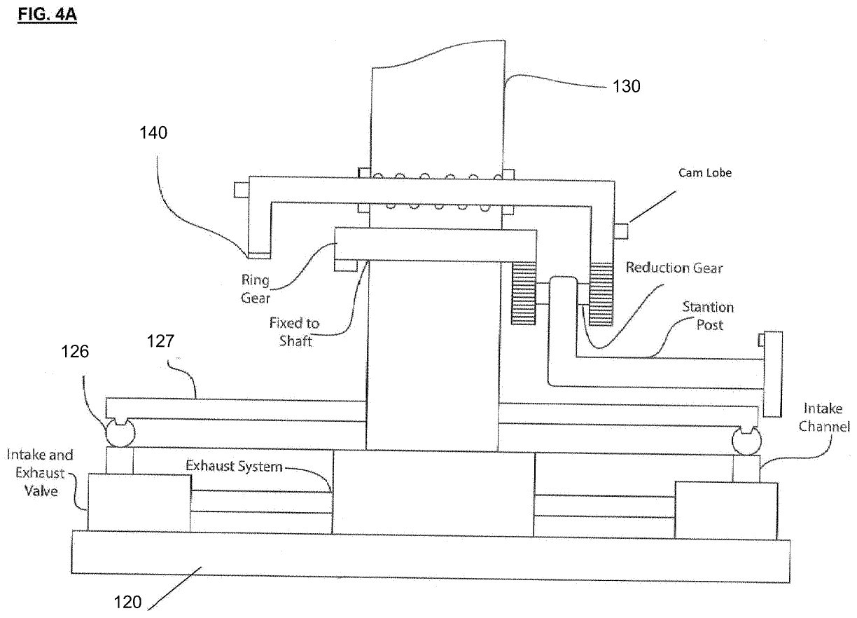

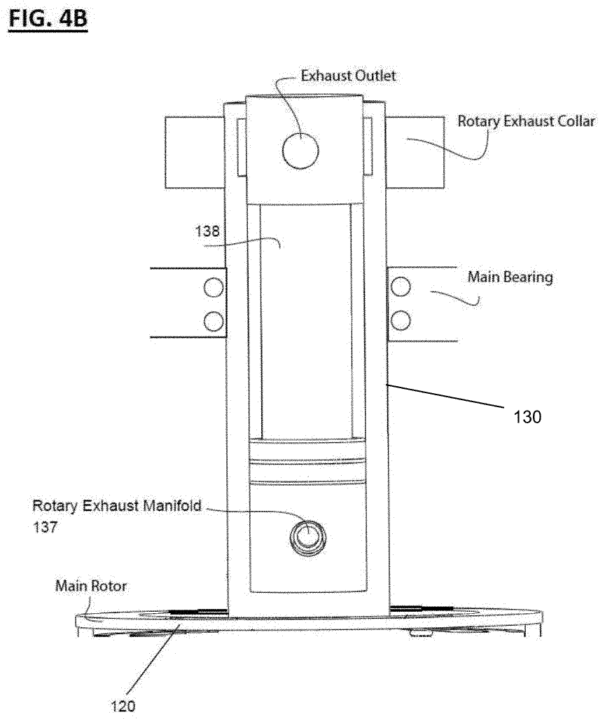

There are several rotating elements that are connected to the spinning cylinder rotor 120 that allow for the system to work efficiently with the rotational action of the cylinders and pistons. The cylinder rotor 120 may be in mechanical connection with a power shaft 130 that translates the rotation of the cylinder rotor 120 to a transmission system (not shown) to utilize the power generated by the engine 100. The power shaft 130 may be fixedly connected to the cylinder rotor 120 such that they rotate together at the same rotational velocity. The intake and exhaust systems as shown in FIGS. 3 and 4 may also be positioned on the cylinder rotor 120 such that they rotate with the cylinder rotor 120 as well. The cylinder rotor 120 may include both intake ports for intake of air-fuel mixture during the intake stroke and exhaust ports to expel the combustion exhaust gas during the exhaust stroke. Each cylinder may have at least one intake port and at least one exhaust port in the cylinder rotor at the top of the cylinder.

FIG. 3 shows a perspective view of the cylinder rotor 120, exhaust system intake system, and power shaft 130 in working assembly. Some structures are shown as transparent for illustrative purposes. The exhaust system may include exhaust valves 135 in fluid communication with each of the cylinders 121, which may control the passage of the exhaust gas through an exhaust port into an exhaust conduit 136 during the exhaust stroke. Each exhaust valve 135 may be operated and opened by a cam system that includes a drum 140 may turn freely with respect to the power shaft 130, but that is in mechanical connection with the rotating cylinder rotor 120, e.g., through a gearing system that times the rotation of the drum 140 such that cams thereon engage and open an exhaust valve 135 at the exhaust stroke for the corresponding cylinder 121. The cam system may include gearing with a ratio that allows it to spin at a different rotational speed than that of the cylinder rotor 120. The cam system gearing may be such that the drum 140 rotates in the same direction as the power shaft 130 at, e.g., one half the rotational speed of the cylinder rotor 120, and on a bearing. In such embodiments, four cam lobes may protrude from the drum to engage valve push rods or other engagement structures of the exhaust valves 125 of each cylinder 121. The cam lobes may be staggered along the axial dimension of the drum 140 and the exhaust valve push rods may be correspondingly staggered such that each cam lobe only engages with the exhaust valve of a particular cylinder 121, allowing the exhaust valves to remain closed during the other stages of the combustion cycle.

An exhaust conduit 136 may be connected to each of the cylinders 121 for passing the exhaust gas to an exhaust manifold 137 that delivers the exhaust gas into the exhaust collection pipe 138. The exhaust manifold 137 may be incorporated into the power shaft 130, where each of the exhaust conduits 136 routes from the exhaust valve 135 of the corresponding cylinder 121 radially inward toward the power shaft 130. The exhaust conduits 136 may connect with an exhaust manifold 137, which may be a cylindrical collar around the power shaft 130. The exhaust conduits 136 may connect with a port in the exhaust manifold 137 that is in fluid connection with the exhaust pipe 138, which rotates with the power shaft 130. The exhaust pipe 138 may be nested within the power shaft 130 and rotate therewith. The exhaust pipe 138 may deliver the exhaust to a stationary receiving pipe or plenum to which the distal end of the exhaust pipe 138 is connected via a rotary union. Because the exhaust pipe 138 rotates with the power shaft 130, rotary union or joint is required to pass the exhaust gas to a static or non-rotating structure. The exhaust pipe may include at least one distal port that allows the exhaust gas to pass into the static structure. The exhaust pipe 138 may be a ceramic material or the interior surface thereof may be lined with a ceramic material in order to prevent corrosion and accumulation of exhaust residue.

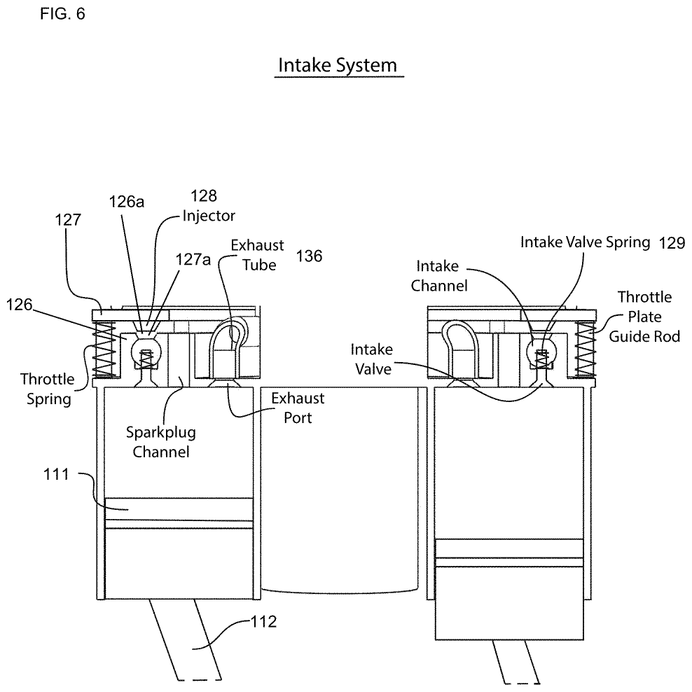

As shown in FIGS. 3 and 6, each cylinder 121 may include an intake port and valve 125a that is in fluid communication with an intake manifold 126. The intake manifold 126 may deliver fuel (e.g., an air fuel mixture) to the intake valves 125 associated with each cylinder. The intake manifold 126 may take the form of a ring chamber positioned at predetermined radius relative to the power shaft 130 and may be in alignment with the intake ports and valves 125. In some embodiments, the intake manifold 126 may include a receiving channel 126a along its entire length on an opposite side thereof from the cylinder rotor 120. The receiving channel 126a may be configured to receive a throttle ring 127 having a complementary shape to that of the receiving channel 126a such that the throttle ring 127 can be adjustably nested within the receiving channel 126a. An adjustable gap 128 may be present between the throttle ring 127 and the receiving channel 126a for allowing air to flow into the intake manifold 126 to provide the air in the air-fuel mixture. The throttle control of the engine may adjust the proximity of the throttle ring 127 in order to adjust the choke of the engine 100. The throttle ring 127 may be in static position relative to the cylinder rotor 120 with the gap 127a between the receiving channel 126a and the throttle ring 127 allowing for the rotation of the intake manifold 126, while the throttle ring 127 remains static.

The throttle ring 127 may be attached to the motor housing 101 or a frame via biased connections that bias the throttle ring 127 toward the closed position. For example, the throttle ring 127 may be connected to the motor housing or frame via studs and biasing springs (not shown) biasing the throttle ring 127 toward the closed position. The studs may include stops that prevent the throttle ring from contacting the receiving channel of the intake manifold 126, preventing full choke. The engine 100 may have a throttle control (not shown) in mechanical connection with the throttle ring 127, allowing an operator to adjust the proximity of the throttle ring 127 to the receiving channel 126a, and thereby adjust the choke of the engine 100.

A fuel injector 128 may be connected to the throttle ring 127 for passing fuel into the intake manifold 126. The fuel injector 128 may be positioned over the point at which the intake valve 125 is opened during the intake stroke and the intake port is exposed allowing the passage of the fuel (e.g., an air-fuel mixture) through the intake port. The fuel injector 128 may be timed to spray fuel into the intake manifold 126 as the intake valve 125 opens, allowing fuel (e.g., the air-fuel mixture) through the intake port and into the open cylinder 121. Air may be introduced into the intake system through the gap 126a between the throttle ring 127 and the intake manifold 126 via passages in the engine housing around the intake system.

An intake valve 125 may control the passage of the air-fuel mixture through the intake port into the corresponding cylinder 121 during the intake stroke. In some embodiments, the intake valve 125 may be operated and opened by negative pressure during the intake stroke, and the intake valve 125 may remain closed during the other stages of the combustion cycle. In some embodiments, the low pressure generated in the cylinder 121 during the intake stroke may be sufficient to open an intake valve 125 for the cylinder 121 to allow the entry of the fuel. The intake valve 125 may include a seated structure in the intake port that is held in the seated position by a biasing device, such as an intake valve spring that biases the structure to the closed position. The force applied by the intake valve spring 129 to the valve structure 125 may be overcome by the vacuum in the cylinder 121 during the intake stroke.

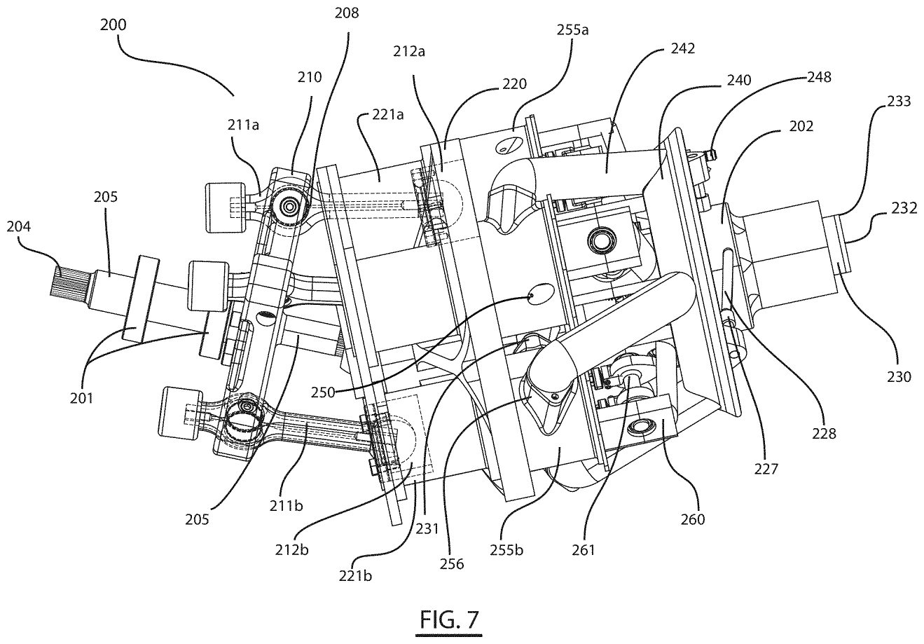

FIG. 7 illustrates an engine according to an embodiment of the present invention. A rotary cylinder and piston system that drives a power shaft to transmit power to a power transmission system for various uses, including powering an automobile, powering a generator, powering a pumping system, and other applications. The engine 200 may be enclosed in a housing 101 as shown in FIG. 1. A power shaft 205 may have a spindle 204 operable to couple to a power transmission assembly (not shown), such as a vehicle transmission. The power shaft 205 may be supported by bearings 201 that is secured to a frame 202 and a housing (not shown). On the cylinder rotor 220, an exhaust shaft 230 may be secured to the frame 202. The piston rotor 210 and cylinder rotor 220 are positioned at an oblique angle relative to one another. The rotors meet at a central plane (e.g., a vertical plane) that may be a pre-determined distance between the cylinder rotor 220 and piston rotor 210. In the embodiment shown in FIGS. 7-11, the central plane may be equidistant from the piston rotor 210 and the cylinder rotor 220. The angles of the cylinder rotor 220 and piston rotor 210 may be the same relative to the central plane. The angled arrangement of the cylinder rotor 220 and the piston rotor 210 creates an oscillating distance between corresponding piston heads and cylinders as the cylinder and piston rotors synchronously rotate. As shown in FIG. 7, multiple piston rods 211a 211b connect the piston heads 212a, 212b to the piston rotor 210. There is one piston rod and piston head for each cylinder in the engine assembly. Each of the piston heads 212a, 212b correspond to a cylinder 221a, 221b (e.g., combustion chamber). Piston 212a and cylinder 221a are illustrated with the dotted lines and are positioned at the top of the cylinder head 255a and at peak of the combustion cycle (e.g., top dead center). At this position, the cylinder rotor 220 and the piston rotor 210 are in their closest proximity, and the piston head 212a is fully inserted into the corresponding cylinder 221a. As the paired cylinder 221a and piston 212a rotate away from top dead center, they progressively move apart until they reach the bottom of the rotational path 180° from top dead center (at bottom dead center), as illustrated by piston 212b and the corresponding cylinder 121b in FIG. 7. As the paired cylinder and piston rotate back toward the top of the rotational path, the piston and cylinder progressively move together.

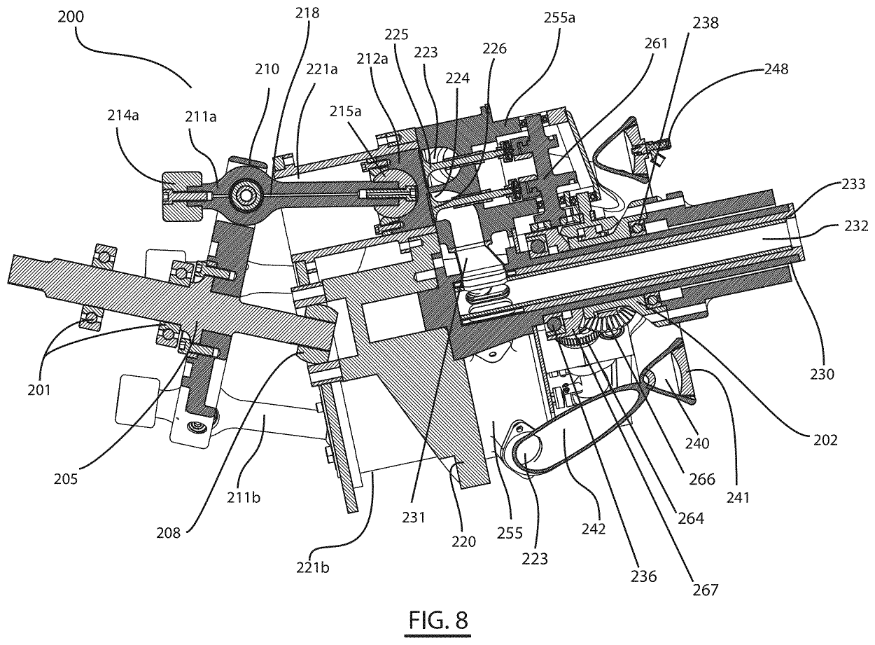

An intake air distributor 240 may collect air and receive fuel from an injector 248 and mix together to form an air-fuel mixture that may be delivered to the cylinder head 255 through an intake runner 242. Each of the cylinders 221 in the cylinder rotor 220 may have a corresponding cylinder head 255 positioned between the air intake distributor 240 and the rotor 220. A cylinder head 255 may include a camshaft system, a spark plug 250, an intake port 223, an exhaust port 224, an intake flange 256, and an exhaust flange 257 and is illustrated in detail in FIGS. 8-11. The air intake distributor 240 may be in communication with a concentric throttle ring 241 that is operable to modulate the volumetric flow rate of air entering into the distributor 240 based on a throttle position. The throttle ring 241 may include a fuel injector 248, and a plurality of throttle roller pins 227 that connect to a plurality of slots 228 positioned concentrically around the frame 202. The slots 228 may provide a cam path (e.g., an oscillating, curved, or helical path) operable to guide the slots on a rotational and translational path when the throttle ring is actuated. There is typically one slot 228 corresponding to each throttle pin 227. The fuel injector 248 may be operable to modulate the quantity of fuel entering into the air intake distributor 240 based on the position of the throttle ring. The series of slots 228 provide a cam path for the throttle pins 227, the cam path may be operable to rotate and translate the throttle ring 214 around the frame 202, thus increasing a gap between the distributor 240 and the ring thereby allowing more air to enter the system.

The piston head 221a at top dead center may have a corresponding cylinder head 255a as shown in FIG. 8 the cylinder head may include an intake port 223, an exhaust port 224, an intake valve 225, and an exhaust valve 226. The cylinder head 255 may expel exhaust from combustion through an exhaust manifold 231 that may be in fluid communication with the exhaust tube 232. Nesting therebetween the exhaust shaft 230 and the exhaust tube 232 is a cooling insert 233 that is operable to provide a moving fluid to absorb heat from the exhaust for routing to a heat exchanger (not shown). The cooling insert may have a series of channels 233F that allow the moving fluid to enter and exit the cooling insert 233. The piston head 212a may be secured to a spherical joint 215a that is fixed to the piston rod 211a. The piston rod 211a may have a counter weight 214a positioned after the piston rotor 210 and may have an oil channel 218 for routing lubrication to the spherical joint 215a and a piston head 221a contact location. The power saft 205 may translate through the piston rotor 210 (e.g., stability shaft) and have on one end a CV joint 208 that is free to rotate with the cylinder rotor 210. This mounting location has no impedance on the rotation of the rotors and may help support the power shaft 205 such that the power shaft is not under the load of a cantilever beam.

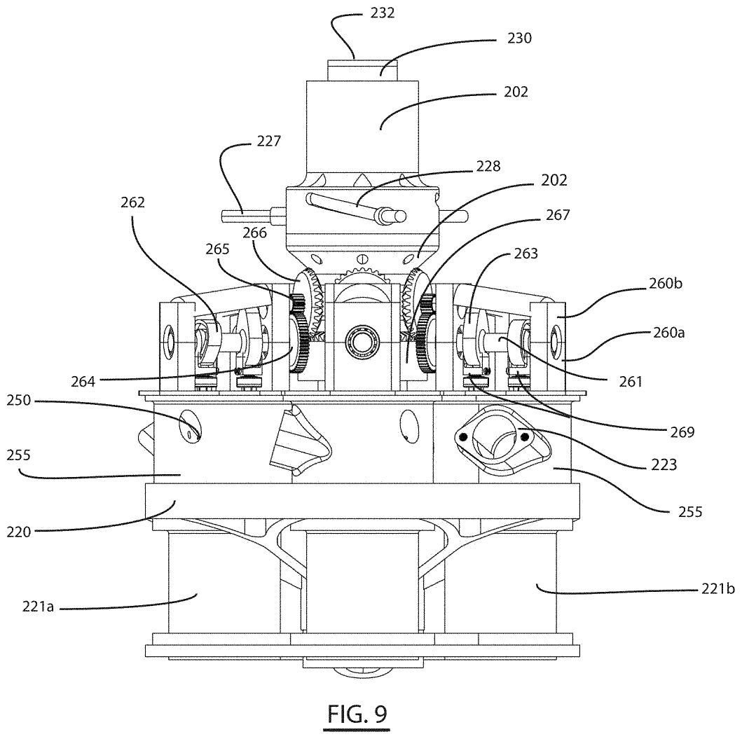

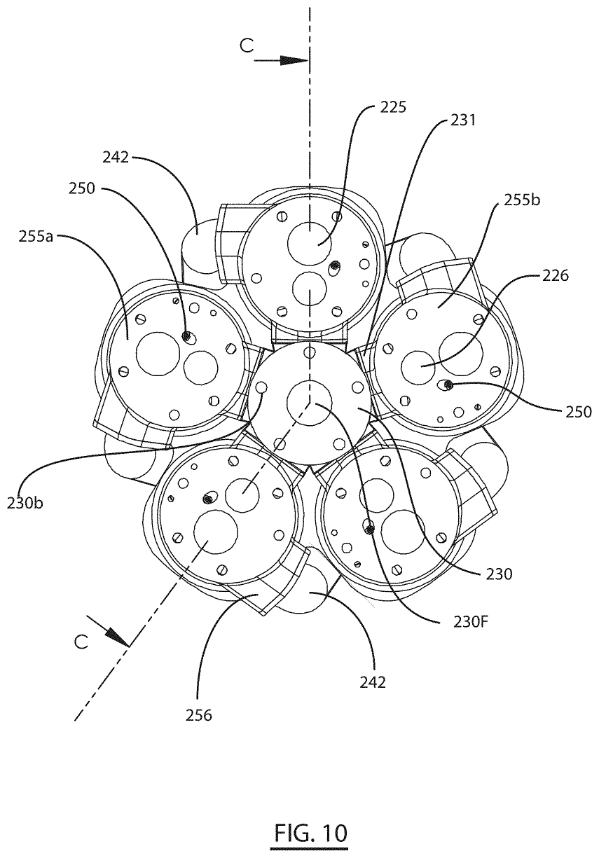

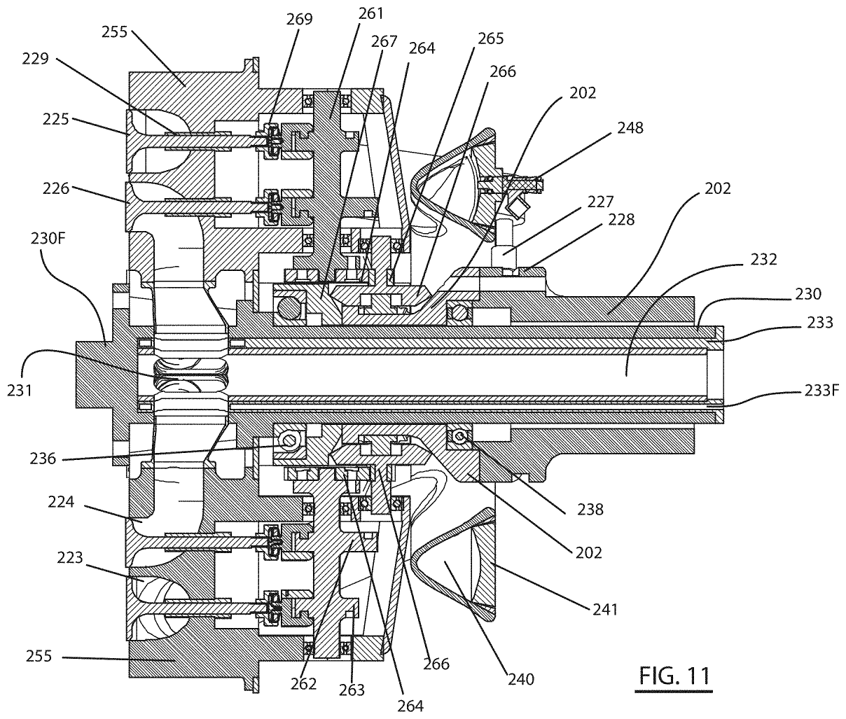

FIG. 9 provides a side view of the cylinder rotor 220 with the intake runners 242, and distributor 240 removed to expose the cam system. FIG. 10 provides a bottom view of the cylinder heads 255 with the combustion chambers 221 and rotor 220 removed. FIG. 11 provides a cross-sectional side view about the line C-C illustrated in FIG. 10 to further illustrate the frame 202, air distributor 240, exhaust shaft 230, cylinder heads 255, and valvetrain components. Each of the cylinder heads may have an independent valvetrain that is operable to provide the air-fuel mixture to the combustion chamber 255 and expel exhaust gases to the exhaust tube 232. The independent valvetrain includes a camshaft 261, intake valve 225, exhaust valve 226, exhaust cam 262, and an intake cam 263. The camshaft 261 may have an exhaust cam 262, and intake cam 263 positioned 90 degrees from each other about the central axis of the camshaft 161. Each of the cams is of the closed-form type, which provides a slot orthogonal to the cam lobe, thereby providing a path to open and close the valve without using a spring. The intake cam 263 and exhaust cam 262 may be connected to their respective valves with a valve retainer 269. Although each of the cylinder heads has an independent valvetrain, the timing of opening and closing each cam lobe corresponds to the rotation of the piston rotor 210 and cylinder rotor 220.

The camshaft 261 may have a cam gear 264 that is in mesh with a reduction gear 265 that shares a common shaft with a timing gear 266. The timing gear 266 meshes with a control gear 267 that is fixed to the frame 202 and does not move when the cylinder rotor and piston rotor are in rotation. As the cylinder rotor 220 rotates around the frame 202, the timing gear 266 (e.g., fan gear) follows the path provided by the control gear 267. The reduction gear 265 rotates at the same rate as the timing gear 266 because they are mounted on the same shaft. The reduction gear 265 meshes with the cam gear 264, and because the reduction gear 265 has one-fourth the number of gear teeth as the cam gear 264 the exhaust cam and intake cam only perform one cycle for every two rotations of the cylinder rotor. Thus the camshaft 261 performs one revolution for every two revolutions of the timing gear 266 around the control gear 267 to provide a four-stroke action of the pistons and rods. During an intake stroke, the intake valve 226 is configured in the open position to allow the air-fuel mixture to enter the combustion chamber 221, this occurs when the piston 212 is translating away from the cylinder head 255. As the cylinder rotor 220 continues rotation, the camshaft 261 rotates, thus configuring the intake valve 226 in a closed position. The piston 212 then begins a compression stroke and advances towards the cylinder head 255. When the piston 212 reaches top dead center, a power stroke begins and a spark plug 250 ignites the compressed air-fuel mixture and combustion occurs, thus translating the piston 212 away from the cylinder head 255. As the cylinder rotor continues rotation, the camshaft rotates and configures the exhaust valve 225 to the open position allowing exhaust gases to exit out of the combustion chamber 221 as the piston 212 advance to the top of the cylinder head 255 during the exhaust stroke.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A rotary engine, comprising:
a. a piston rotor having a plurality of pistons thereon and positioned on a first rotational axis;
b. a cylinder rotor having a plurality of cylinders thereon and positioned on a second rotational axis; and
c. a power shaft for transmitting rotational motion from one of the piston rotor and cylinder rotor to a transmission system for providing mechanical power to another system,
wherein the first rotational axis and the second rotational axis are oblique relative to one another, and each of said plurality of pistons is nested in one of said plurality of cylinders and the rotation of said piston rotor and said cylinder rotor is driven by combustion of a fuel in said cylinders.

2. The engine of claim 1, wherein the first and second rotational axes are positioned on a same plane.

3. The engine of claim 1, wherein an angle between the first rotational axis and the second rotational axis is in a range of about 120° to about 160°.

4. The engine of claim 1, wherein said pistons each include a piston head connected to a piston rod by a movable joint.

5. The engine of claim 4, wherein said movable joint is a ball joint.

6. The engine of claim 4, wherein said piston rod is connected to said piston rotor by a movable joint.

7. The engine of claim 4, wherein said piston rod is fixedly attached to said piston rotor.

8. The engine of claim 4, wherein said piston rod is substantially orthogonal to the surface of the piston rotor.

9. The engine of claim 1, wherein due to the angle of the relative angle of the piston rotor and the cylinder rotor, synchronous rotation of the piston rotor and the cylinder rotor results in a reciprocating motion of each piston within the corresponding cylinder, wherein the piston head of each piston penetrates furthest into the corresponding cylinder at a proximal point in its rotational path that is nearest to the cylinder rotor and the piston is at its most retracted point in corresponding cylinder at a distal point in its rotational path that is furthest from the cylinder rotor.

10. The engine of claim 9, wherein combustion occurs at or near said proximal point.

11. The engine of claim 9, wherein said piston head is at top dead center at said proximal point.

12. The engine of claim 9, wherein intake occurs at or near said distal point.

13. The engine of claim 9, wherein said piston head is at bottom dead center at said distal point.

14. The engine of claim 13, wherein said engine is a four-stroke engine and the combustion cycle is completed in two full rotations of the piston rotor and the cylinder rotor.

15. The engine of claim 13, wherein each stroke of said combustion cycle occurs over a 180° turn of the piston rotor and cylinder rotor.

16. The engine of claim 1, further comprising a fuel intake system comprising an intake manifold and a throttle mechanism.

17. The engine of claim 16, wherein said intake manifold includes a tube that is connected to said cylinder rotor and rotates with said cylinder rotor.

18. The engine of claim 17, wherein said tube has a substantially circular cross-section and has a ring shape that is concentric with the cylinder rotor and includes fuel delivery passages that are in fluid communication with each of said plurality of cylinders in said cylinder rotor.

19. The engine of claim 18, wherein said tube includes a channel that runs the entire length of the tube on the side of the tube opposite from said cylinder rotor.

20. The engine of claim 19, further comprising a throttle system that includes throttle ring having a cross-sectional shape that is complementary to the channel in said tube, and a throttle control that is operable to move the throttle ring in and out of said channel to adjust the amount of allowed to flow into the tube.

21. The engine of claim 20, further comprising a fuel injector for injecting fuel into said tube, wherein said fuel injector is connected to said throttle ring and is positioned to inject fuel directly into said tube.

22. The engine of claim 21, wherein said throttle ring and said fuel injector are stationary with respect to the cylinder rotor and the tube.

23. The engine of claim 18, wherein each of said plurality of cylinders includes an intake valve in fluid communication with said tube, and is opened by the vacuum created by an intake stroke of a corresponding piston.

24. The engine of claim 1, further comprising an exhaust system comprising an exhaust manifold and an exhaust valve timing mechanism.

25. The engine of claim 24, wherein each of said plurality of cylinders includes an exhaust valve in fluid communication with said cylinder an exhaust conduit, wherein said exhaust conduit is in fluid communication with said exhaust manifold.

26. The engine of claim 25, wherein said exhaust manifold is mounted on said power shaft and rotates with said power shaft.

27. The engine of claim 26, wherein said exhaust conduits are connected to said cylinder rotor and rotate with said cylinder rotor.

28. The engine of claim 27, wherein said exhaust conduits connect ports in said exhaust manifold that are in fluid communication with an exhaust pipe that routes exhaust out of the engine.

29. The engine of claim 27, wherein said exhaust pipe rotates with said power shaft.

30. The engine of claim 29, wherein said exhaust pipe is nested in said power shaft.

31. The engine of claim 25, wherein said exhaust valve timing system includes a cam drum that rotates independently of said power shaft.

32. The engine of claim 31, wherein the cam drum is indirect mechanical communication with the cylinder rotor via a gearing system that rotates said cam drum at a pre-determined speed relative to said cylinder rotor.

33. The engine of claim 32, wherein said cam drum includes at least one cam for actuating the exhaust valve of each of said plurality of cylinders, wherein said at least one cam actuates said exhaust valve of each of said plurality of cylinders during exhaust stroke.

34. A rotary engine, comprising:
a. a piston rotor having a plurality of pistons thereon and positioned on a first rotational axis; and
b. a cylinder rotor having a plurality of cylinders thereon and positioned on a second rotational axis, wherein the first rotational axis and the second rotational axis are oblique relative to one another, and each of said plurality of pistons is nested in one of said plurality of cylinders and the rotation of said piston rotor and said cylinder rotor is driven by combustion of a fuel in said cylinders.

35. The engine of claim 34, further comprising a power shaft for transmitting rotational motion from one of the piston rotor and cylinder rotor to a transmission system for providing mechanical power to another system,

36. The engine of claim 34, wherein the first and second rotational axes are positioned on a same plane.

37. The engine of claim 34, wherein an angle between the first rotational axis and the second rotational axis is in a range of about 120° to about 160°.

38. The engine of claim 34, wherein said pistons each include a piston head connected to a piston rod by a movable joint.

39. The engine of claim 38, wherein said movable joint is a ball joint.

40. The engine of claim 38, wherein said piston rod is connected to said piston rotor by a movable joint.

41. The engine of claim 38, wherein said piston rod is fixedly attached to said piston rotor.

42. The engine of claim 38, wherein said piston rod is substantially orthogonal to the surface of the piston rotor.

43. The engine of claim 34, wherein due to the angle of the relative angle of the piston rotor and the cylinder rotor, synchronous rotation of the piston rotor and the cylinder rotor results in a reciprocating motion of each piston within the corresponding cylinder, wherein the piston head of each piston penetrates furthest into the corresponding cylinder at a proximal point in its rotational path that is nearest to the cylinder rotor and the piston is at its most retracted point in corresponding cylinder at a distal point in its rotational path that is furthest from the cylinder rotor.

44. The engine of claim 43, wherein combustion occurs at or near said proximal point.

45. The engine of claim 43, wherein said piston head is at top dead center at said proximal point.

46. The engine of claim 43, wherein intake occurs at or near said distal point.

47. The engine of claim 43, wherein said piston head is at bottom dead center at said distal point.

48. The engine of claim 13, wherein said engine is a four-stroke engine and the combustion cycle is completed in two full rotations of the piston rotor and the cylinder rotor.

49. The engine of claim 48, wherein each stroke of said combustion cycle occurs over a 180° turn of the piston rotor and cylinder rotor.

50. The engine of claim 34, further comprising a fuel intake system comprising an intake manifold and a throttle mechanism.

51. The engine of claim 50, wherein said intake manifold includes a tube that is connected to said cylinder rotor and rotates with said cylinder rotor.

52. The engine of claim 51, wherein said tube has a substantially circular cross-section and has a ring shape that is concentric with the cylinder rotor and includes fuel delivery passages that are in fluid communication with each of said plurality of cylinders in said cylinder rotor.

53. The engine of claim 52, wherein said tube includes a channel that runs the entire length of the tube on the side of the tube opposite from said cylinder rotor.

54. The engine of claim 53, further comprising a throttle system that includes throttle ring having a cross-sectional shape that is complementary to the channel in said tube, and a throttle control that is operable to move the throttle ring in and out of said channel to adjust the amount of allowed to flow into the tube.

55. The engine of claim 54, further comprising a fuel injector for injecting fuel into said tube, wherein said fuel injector is connected to said throttle ring and is positioned to inject fuel directly into said tube.

56. The engine of claim 55, wherein said throttle ring and said fuel injector are stationary with respect to the cylinder rotor and the tube

57. The engine of claim 52, wherein each of said plurality of cylinders includes an intake valve in fluid communication with said tube, and is opened by the vacuum created by an intake stroke of a corresponding piston.

58. The engine of claim 34, further comprising an exhaust system comprising an exhaust manifold and an exhaust valve timing mechanism.

59. The engine of claim 58, wherein each of said plurality of cylinders includes an exhaust valve in fluid communication with said cylinder an exhaust conduit, wherein said exhaust conduit is in fluid communication with said exhaust manifold.

60. The engine of claim 59, wherein said exhaust manifold is mounted on said power shaft and rotates with said power shaft.

61. The engine of claim 60, wherein said exhaust conduits are connected to said cylinder rotor and rotate with said cylinder rotor.

62. The engine of claim 61, wherein said exhaust conduits connect ports in said exhaust manifold that are in fluid communication with an exhaust pipe that routes exhaust out of the engine.

63. The engine of claim 61, wherein said exhaust pipe rotates with said power shaft.

64. The engine of claim 63, wherein said exhaust pipe is nested in said power shaft.

65. The engine of claim 59, wherein said exhaust valve timing system includes a cam drum that rotates independently of said power shaft.

66. The engine of claim 65, wherein the cam drum is indirect mechanical communication with the cylinder rotor via a gearing system that rotates said cam drum at a pre-determined speed relative to said cylinder rotor.

67. The engine of claim 66, wherein said cam drum includes at least one cam for actuating the exhaust valve of each of said plurality of cylinders, wherein said at least one cam actuates said exhaust valve of each of said plurality of cylinders during exhaust stroke.

68. A mechanical apparatus, comprising:
a. a piston rotor having a plurality of pistons thereon and positioned on a first rotational axis; and
b. a cylinder rotor having a plurality of cylinders thereon and positioned on a second rotational axis, wherein the first rotational axis and the second rotational axis are oblique relative to one another, and each of said plurality of pistons is nested in one of said plurality of cylinders.

69. The apparatus of claim 68, wherein the first and second rotational axes are positioned on a same plane.

70. The apparatus of claim 68, wherein an angle between the first rotational axis and the second rotational axis is in a range of about 120° to about 160°.

71. The apparatus of claim 68, wherein said pistons each include a piston head connected to a piston rod by a movable joint.

72. The apparatus of claim 71, wherein said movable joint is a ball joint.

73. The apparatus of claim 71, wherein said piston rod is connected to said piston rotor by a movable joint.

74. The apparatus of claim 71, wherein said piston rod is fixedly attached to said piston rotor.

75. The apparatus of claim 71, wherein said piston rod is substantially orthogonal to the surface of the piston rotor.

76. The apparatus of claim 68, wherein due to the angle of the relative angle of the piston rotor and the cylinder rotor, synchronous rotation of the piston rotor and the cylinder rotor results in a reciprocating motion of each piston within the corresponding cylinder, wherein the piston head of each piston penetrates furthest into the corresponding cylinder at a proximal point in its rotational path that is nearest to the cylinder rotor and the piston is at its most retracted point in corresponding cylinder at a distal point in its rotational path that is furthest from the cylinder rotor.

77. The apparatus of claim 68, further comprising a fluid intake system comprising an intake manifold.

78. The apparatus of claim 68, further comprising a fluid exhaust system comprising an exhaust manifold.

79. The apparatus of claim 78, wherein each of said plurality of cylinders includes an exhaust passage in fluid communication with an exhaust conduit, wherein said exhaust conduit is in fluid communication with said exhaust manifold.

80. The apparatus of claim 78, wherein said exhaust conduits are connected to said cylinder rotor and rotate with said cylinder rotor.

81. The apparatus of claim 61, wherein said exhaust conduits connect ports in said exhaust manifold that are in fluid communication with a fluid exhaust conduit that routes fluid out of the apparatus.

82. A method of generating propulsive force, comprising:
a. positioning a plurality of pistons connected to a piston rotor positioned on a first rotational axis in a plurality of cylinders positioned on a cylinder rotor positioned on a second rotational axis to form a plurality of paired pistons and cylinders, wherein the first rotational axis and the second rotational axis are oblique relative to one another; and
b. combusting a fuel in said paired pistons and cylinders in a sequential pattern to drive rotation of said piston rotor and said cylinder rotor, wherein said rotation of one of said piston rotor and said cylinder rotor drives rotation of a power shaft for transmitting rotational motion from one of the piston rotor and cylinder rotor to a transmission system for providing mechanical power to another system.

83. The method of claim 82, wherein the first and second rotational axes are positioned on a same plane.

84. The method of claim 82, wherein an angle between the first rotational axis and the second rotational axis is in a range of about 120° to about 160°.

85. The method of claim 82, wherein said pistons each include a piston head connected to a piston rod by a movable joint.

86. The method of claim 85, wherein said movable joint is a ball joint.

87. The method of claim 85, wherein said piston rod is connected to said piston rotor by a movable joint.

88. The method of claim 85, wherein said piston rod is fixedly attached to said piston rotor.

89. The method of claim 85, wherein said piston rod is substantially orthogonal to the surface of the piston rotor.

90. The method of claim 82, wherein due to the angle of the relative angle of the piston rotor and the cylinder rotor, synchronous rotation of the piston rotor and the cylinder rotor results in a reciprocating motion of each piston within the corresponding cylinder, wherein the piston head of each piston penetrates furthest into the corresponding cylinder at a proximal point in its rotational path that is nearest to the cylinder rotor and the piston is at its most retracted point in corresponding cylinder at a distal point in its rotational path that is furthest from the cylinder rotor.

91. The method of claim 90, wherein combustion occurs at or near said proximal point.

92. The method of claim 90, wherein said piston head is at top dead center at said proximal point.

93. The method of claim 90, wherein intake occurs at or near said distal point.

94. The method of claim 90, wherein said piston head is at bottom dead center at said distal point.

95. The method of claim 94, wherein said engine is a four-stroke engine and the combustion cycle is completed in two full rotations of the piston rotor and the cylinder rotor.

96. The method of claim 94, wherein each stroke of said combustion cycle occurs over a 180° turn of the piston rotor and cylinder rotor.

97. The method of claim 82, wherein the piston rotor and cylinder rotor are incorporated into an engine that includes a fuel intake system comprising an intake manifold and a throttle mechanism.

98. The method of claim 97, wherein said intake manifold includes a tube that is connected to said cylinder rotor and rotates with said cylinder rotor.

99. The method of claim 98, wherein said tube has a substantially circular cross-section and has a ring shape that is concentric with the cylinder rotor and includes fuel delivery passages that are in fluid communication with each of said plurality of cylinders in said cylinder rotor.

100. The method of claim 99, wherein said tube includes a channel that runs the entire length of the tube on the side of the tube opposite from said cylinder rotor.

101. The method of claim 100, wherein the engine includes a throttle system that includes throttle ring having a cross-sectional shape that is complementary to the channel in said tube, and a throttle control that is operable to move the throttle ring in and out of said channel to adjust the amount of allowed to flow into the tube.

102. The method of claim 101, wherein the engine includes a fuel injector for injecting fuel into said tube, wherein said fuel injector is connected to said throttle ring and is positioned to inject fuel directly into said tube.

103. The method of claim 102, wherein said throttle ring and said fuel injector are stationary with respect to the cylinder rotor and the tube

104. The method of claim 99, wherein each of said plurality of cylinders includes an intake valve in fluid communication with said tube, and is opened by the vacuum created by an intake stroke of a corresponding piston.

105. The method of claim 82, wherein said engine includes an exhaust system comprising an exhaust manifold and an exhaust valve timing mechanism.

106. The method of claim 105, wherein each of said plurality of cylinders includes an exhaust valve in fluid communication with said cylinder an exhaust conduit, wherein said exhaust conduit is in fluid communication with said exhaust manifold.

107. The method of claim 106, wherein said exhaust manifold is mounted on said power shaft and rotates with said power shaft.

108. The method of claim 107, wherein said exhaust conduits are connected to said cylinder rotor and rotate with said cylinder rotor.

109. The method of claim 108, wherein said exhaust conduits connect ports in said exhaust manifold that are in fluid communication with an exhaust pipe that routes exhaust out of the engine.

110. The method of claim 108, wherein said exhaust pipe rotates with said power shaft.

111. The method of claim 110, wherein said exhaust pipe is nested in said power shaft.

112. The method of claim 106, wherein said exhaust valve timing system includes a cam drum that rotates independently of said power shaft.

113. The method of claim 112, wherein the cam drum is indirect mechanical communication with the cylinder rotor via a gearing system that rotates said cam drum at a pre-determined speed relative to said cylinder rotor.

114. The method of claim 113, wherein said cam drum includes at least one cam for actuating the exhaust valve of each of said plurality of cylinders, wherein said at least one cam actuates said exhaust valve of each of said plurality of cylinders during exhaust stroke.

115. A method of fluid movement, comprising:
a. positioning a plurality of pistons connected to a piston rotor positioned on a first rotational axis in a plurality of cylinders positioned on a cylinder rotor positioned on a second rotational axis to form a plurality of paired pistons and cylinders, wherein the first rotational axis and the second rotational axis are oblique relative to one another; and
b. moving a fluid through said paired pistons and cylinders in a sequential pattern, wherein said rotation of one of said piston rotor and said cylinder rotor results in movement of said fluid from said cylinders into an exhaust system.

116. The method of claim 115, wherein the first and second rotational axes are positioned on a same plane.

117. The method of claim 115, wherein an angle between the first rotational axis and the second rotational axis is in a range of about 120° to about 160°.

118. The method of claim 115, wherein said pistons each include a piston head connected to a piston rod by a movable joint.

119. The method of claim 118, wherein said movable joint is a ball joint.

120. The method of claim 118, wherein said piston rod is connected to said piston rotor by a movable joint.

121. The method of claim 118, wherein said piston rod is fixedly attached to said piston rotor.

122. The method of claim 118, wherein said piston rod is substantially orthogonal to the surface of the piston rotor.

123. The method of claim 115, wherein due to the angle of the relative angle of the piston rotor and the cylinder rotor, synchronous rotation of the piston rotor and the cylinder rotor results in a reciprocating motion of each piston within the corresponding cylinder, wherein the piston head of each piston penetrates furthest into the corresponding cylinder at a proximal point in its rotational path that is nearest to the cylinder rotor and the piston is at its most retracted point in corresponding cylinder at a distal point in its rotational path that is furthest from the cylinder rotor.

124. The method of claim 115, wherein said paired pistons and rotors are incorporated into an apparatus that includes a fluid intake system comprising an intake manifold.

125. The method of claim 124, wherein said intake manifold includes a tube that is connected to said cylinder rotor and rotates with said cylinder rotor.

126. The method of claim 125, wherein said tube has a substantially circular cross-section and has a ring shape that is concentric with the cylinder rotor and includes fluid delivery passages that are in fluid communication with each of said plurality of cylinders in said cylinder rotor.

127. The method of claim 115, wherein said paired pistons and rotors are incorporated into an apparatus that includes an exhaust system comprising an exhaust manifold and an exhaust valve timing mechanism.

128. The method of claim 127, wherein each of said plurality of cylinders includes an exhaust valve in fluid communication with said cylinder an exhaust conduit, wherein said exhaust conduit is in fluid communication with said exhaust manifold.

129. The method of claim 128, wherein said exhaust conduits are connected to said cylinder rotor and rotate with said cylinder rotor.

130. The method of claim 129, wherein said exhaust conduits connect ports in said exhaust manifold that are in fluid communication with an exhaust pipe that routes fluid out of the apparatus.

131. A rotary engine, comprising:
a. a piston rotor having a plurality of pistons thereon and positioned on a first rotational axis;
b. a cylinder rotor having a plurality of cylinders thereon and positioned on a second rotational axis; and
c. a power shaft for transmitting rotational motion from one of the piston rotor and cylinder rotor to a transmission system for providing mechanical power to another system,
wherein the first rotational axis and the second rotational axis are oblique relative to one another, and each of said plurality of pistons is nested in one of said plurality of cylinders and the rotation of said piston rotor and said cylinder rotor is driven by combustion of a fuel in said cylinders.

132. The engine of claim 131, wherein the first and second rotational axes are positioned on a same plane.

133. The engine of claim 131, wherein an angle between the first rotational axis and the second rotational axis is in a range of about 120° to about 160°.

134. The engine of claim 131, wherein said pistons each include a piston head connected to a piston rod by a movable joint.

135. The engine of claim 134, wherein said piston rod is connected to said piston rotor by a movable joint.

136. The engine of claim 134, wherein said piston rod is substantially orthogonal to the surface of the piston rotor.

137. The engine of claim 131, wherein due to the angle of the relative angle of the piston rotor and the cylinder rotor, synchronous rotation of the piston rotor and the cylinder rotor results in a reciprocating motion of each piston within the corresponding cylinder, wherein the piston head of each piston penetrates furthest into the corresponding cylinder at a proximal point in its rotational path that is nearest to the cylinder rotor and the piston is at its most retracted point in corresponding cylinder at a distal point in its rotational path that is furthest from the cylinder rotor.

138. The engine of claim 137, wherein combustion occurs at or near said proximal point.

139. The engine of claim 131, further comprising a plurality of independent cylinder heads positioned adjacent to said cylinder rotor and concentric to each of said plurality of cylinders, wherein the independent cylinder head includes a camshaft, an intake valve, an exhaust valve, an intake port receiving an air fuel mixture, and an exhaust port for directing combustion products.

140. The engine of claim 139, wherein said camshaft has a neutral axis positioned orthogonal to said central axis of said cylinder rotor, an intake cam fixed to the camshaft and position adjacent to the central axis of said intake valve, and an exhaust cam fixed to the camshaft and position adjacent to the central axis of said exhaust valve.

141. The engine of claim 140, wherein both of said intake cam and exhaust cam has an interior grove in fluid communication with a rotatable pin secured to a valve retainer that is perpendicularly positioned to a valve stems proximal point of each of said intake valve and exhaust valve.

142. The engine of claim 139, wherein said camshaft is operable to translate the intake valve and exhaust valve to an open position and a closed position.

143. The engine of claim 139, wherein said camshaft has a cam gear in synchronism with a valvetrain comprising a control gear in mesh with a timing gear, of which, is secured to a timing shaft having a reduction gear in mesh with said cam gear.

144. The engine of claim 143, wherein said control gear is concentrically positioned about said cylinder rotors rotational axis and is fixed to a frame, and said timing shaft is axially secured said cylinder head in a orthogonal fashion.

145. The engine of claim 131, further comprising a fuel intake system comprising an intake manifold, and a throttle mechanism, wherein said intake manifold includes a tube that is connected to said cylinder rotor and rotates with said cylinder rotor.

146. The engine of claim 145, wherein said tube has a substantially circular cross-section and has a ring shape that is concentric with the cylinder rotor and includes an intake runner in fluid communication with each intake port of said plurality of cylinder heads in said cylinder rotor.

147. The engine of claim 146, wherein each of said plurality of cylinder heads having said intake valve in fluid communication with said intake port, and is opened by said intake cam and vacuum created by an intake stroke of the corresponding piston head.

148. The engine of claim 131, further comprising an exhaust system comprising an exhaust manifold, an exhaust tube, an exhaust shaft, and a cooling insert, wherein said exhaust manifold is in fluid communication with said exhaust port of said cylinder head and is operable to direct said combustion products from said cylinder upon translation of said exhaust valve.

149. The engine of claim 148, wherein said exhaust shaft includes an exhaust conduit aligned with said exhaust manifold and is aligned with an exhaust conduit of said cooling insert for routing said combustion products to said exhaust tube.

150. The engine of claim 149, wherein said cooling insert includes a cold side in contact with said exhaust shaft, a hot side in contact with said exhaust tube, and a passage operable to receive a thermal fluid operable to absorb heat and prevent excessive heat transfer to said exhaust shaft.

151. The engine of claim 148, wherein said exhaust shaft is concentrically aligned with said rotational axis of said cylinder rotor, and is fixed to said cylinder rotor.

152. The engine of claim 131, wherein said cylinder rotor includes said power shaft positioned concentrically to said piston rotor rotational axis.

153. The engine of claim 131, further includes a stability shaft fixed to said piston rotor and is secured to a movable joint at said rotational axis of said cylinder rotor, wherein said stability is operable to freely rotate and stabilize said piston rotor.
